(19) United States
(12) Patent Application Publication
(10) Pub. No.: US 2009/0027724 A1
(43) Pub. Date: Jan. 29, 2009

(54) Data processing method, data management device, and information processing device

(75) Inventors: Takuya Nagase, Tokyo (JP); Toru Akutsu, Tokyo (JP)

Correspondence Address: HARNESS, DICKEY & PIERCE, P.L.C., P.O. BOX 8910, RESTON, VA, 20195, US

(73) Assignee: RICOH COMPANY, LTD.

(21) Appl. No.: 12/219,716

(22) Filed: Jul. 28, 2008

(30) Foreign Application Priority Data
Jul. 27, 2007 (JP) 2007-196170

(51) Int. Cl. G06F 3/12

(52) U.S. Cl. 358/1.15

(57) ABSTRACT

In a data processing method for a data processing system including an apparatus having a storing unit for storing data, and an information processing device for performing data processing in accordance with a predetermined procedure are interconnected via a network, it is detected whether a processing object data, which is an object of data processing to be performed by the information processing device, is stored in a predetermined storage area of the storing unit of the apparatus. A request of data processing of the processing object data is transmitted from the apparatus to the information processing device based on a result of the detection. Data processing to the processing object data is performed in response to the request received from the apparatus.

### BACKGROUND OF THE INVENTION

1. Field of the Invention

This invention relates to a data processing method and a data processing device which perform data processing according to a predetermined procedure, such as a work flow.

2. Description of the Related Art

Among various kinds of data including documents, images, etc. which are dealt with for office work, there are a large number of data items which are processed through various work flows in order to carry out office work. The problem being considered in such data processing is that an operator in charge must process every work step using an electronic apparatus, such as a PC (personal computer) or an MFP (multi-function peripheral). In such a case, if the number of work steps to be performed is large, the burden to the operator in charge will be increased. If the work steps are complicated, the probability that the operator in charge makes a mistake will be raised.

To eliminate the problem, in recent years, work flow management systems or software modules for carrying out a series of work steps efficiently have been developed. In such a work flow management system, the procedure (work flow) for performing a series of work through a plurality of work steps is specified in order to carry out business work smoothly.

For example, Japanese Laid-Open Patent Application No. 2002-287864 discloses a wizard-function system. In this system, an operator in charge is caused to select the sequence and the layout of a series of work steps so that the processes of operation in the series of work steps are set up, each process of operation is displayed on a display screen sequentially in a dialogic form (a dialogic form using a wizard function), and the work flow is executed by using a UI (User Interface) of each display screen.

Moreover, in order to carry out a series of work steps more easily, a software module which carries out a series of work steps as one function by performing a set of small functions, each being an extended minimum-unit function, in accordance with a predetermined sequence of execution.

However, in the above-mentioned technology according to the related art, unless the operator in charge selects the data item as a processing object or inputs a command to execute the procedure for performing a series of work steps, the series of work steps cannot be performed.

Although there is a demand for processing automatically the routine work which occurs frequently in business work, the above-mentioned technology according to the related art is still inadequate for easing the burden to the operator in charge and for lowering the probability that the operator in charge makes a mistake (or omission in work).

### SUMMARY OF THE INVENTION

In one aspect of the invention, the present disclosure provides an improved data processing method and device in which the above-described problems are eliminated.

In one aspect of the invention, the present disclosure provides a data processing method, a data management device, and an information processing device which are adapted for easing the burden to the operator in charge in data processing and for lowering the probability that the operator in charge makes a mistake (or omission in work).

In an embodiment of the invention which solves or reduces one or more of the above-mentioned problems, the present disclosure provides a data processing method for use in a data processing system in which an apparatus having a storing unit for storing data, and an information processing device for performing data processing in accordance with a predetermined procedure are interconnected via a network, the data processing method comprising: a processing object data detecting step of detecting whether a processing object data, which is an object of data processing to be performed by the information processing device, is stored in a predetermined storage area of the storing unit of the apparatus; a processing request step of transmitting a request of data processing of the processing object data from the apparatus to the information processing device based on a result of the detection in the processing object data detecting step; and a work flow executing step of performing data processing to the processing object data in response to the request received from the apparatus.

In an embodiment of the invention which solves or reduces one or more of the above-mentioned problems, the present disclosure provides a data management device connected with an information processing device which performs data processing in accordance with a predetermined procedure, the data management device managing a processing object data which is stored in a storing unit as being an object of data processing being performed by the information processing device, the data management device comprising: a processing object data detecting unit configured to detect whether the processing object data is stored in a predetermined storage area of the storing unit of the data management device; and a processing request unit configured to transmit a request of data processing of the processing object data from the data management device to the information processing device based on a detection result of the processing object data detecting unit.

In an embodiment of the invention which solves or reduces one or more of the above-mentioned problems, the present disclosure provides an information processing device comprising: a unit configured to perform data processing in accordance with a predetermined procedure; and a work flow executing unit configured to perform data processing to a processing object data which is an object of data processing performed by the information processing device, in response to a processing request.

In the data processing method, the data management device, or the information processing device of the invention, when it is determined that a data operation, such as storing or updating of data, is performed with respect to data as a data-processing object, the data processing is automatically in accordance with the predetermined procedure associated with the data as the data-processing object. It is possible to ease the burden to the operator in charge in data processing and lower the possibility that the operator in charge makes a mistake (or omission in work).

Other objects, features and advantages of the present invention will be more apparent from the following detailed description when read in conjunction with the accompanying drawings.

### BRIEF DESCRIPTION OF THE DRAWINGS

FIG. 1 is a diagram showing the composition of a data processing system of a first embodiment of the invention.

FIG. 2 is a block diagram showing the hardware composition of an information processing device and a server (data management device) in the data processing system of the first embodiment.

FIG. 3 is a block diagram showing the hardware composition of an image forming device in the data processing system of the first embodiment.

FIG. 4 is a block diagram showing the functional composition of the data processing system of the first embodiment.

FIG. 5 is a diagram showing an example of processing object definition data in the first embodiment.

FIG. 6 is a diagram showing an example of work flow definition data in the first embodiment.

FIG. 7 is a diagram showing the screen composition of a display screen in the first embodiment.

FIG. 8 is a diagram showing an example of a display screen during operation of the data processing system of the first embodiment.

FIG. 9 is a diagram showing an example of a display screen during operation of the data processing system of the first embodiment.

FIG. 10 is a diagram showing an example of a display screen during operation of the data processing system of the first embodiment.

FIG. 11 is a diagram showing an example of a display screen during operation of the data processing system of the first embodiment.

FIG. 12 is a flowchart for explaining the procedure performed by the information processing device of the first embodiment at a time of execution of a work flow.

FIG. 13 is a flowchart for explaining the procedure performed by the server (data management device) of the first embodiment when transmitting a processing request.

FIG. 14 is a block diagram showing the functional composition of an information processing device in a data processing system of a second embodiment of the invention.

FIG. 15 is a diagram showing an example of a work flow definition data in the second embodiment.

FIG. 16 is a flowchart for explaining the procedure of an access control function at a time of execution of a work flow in the second embodiment.

FIG. 17 is a diagram showing the functional composition of an information processing device in a data processing system of a third embodiment of the invention.

FIG. 18 is a flowchart for explaining the procedure performed by the information processing device of the third embodiment at a time of execution of a work flow.

FIG. 19 is a diagram showing an example of a display screen during operation of the data processing system of the third embodiment.

FIG. 20 is a flowchart for explaining the procedure of a work flow setting function in the third embodiment at a time of execution of a work flow.

FIG. 21 is a diagram showing an example of a display screen during operation of the data processing system of the third embodiment.

FIG. 22 is a flowchart for explaining the procedure of a work flow setting function in the third embodiment at a time of execution of a work flow.

FIG. 23 is a diagram showing the functional composition of the data processing system of the third embodiment.

FIG. 24 is a diagram showing the composition of a modification of the data processing system of the invention.

FIG. 25 is a block diagram showing the functional composition of a modification of the data processing system of the invention.

### DETAILED DESCRIPTION OF THE PREFERRED EMBODIMENTS

A description will be given of embodiments of the invention with reference to the accompanying drawings.

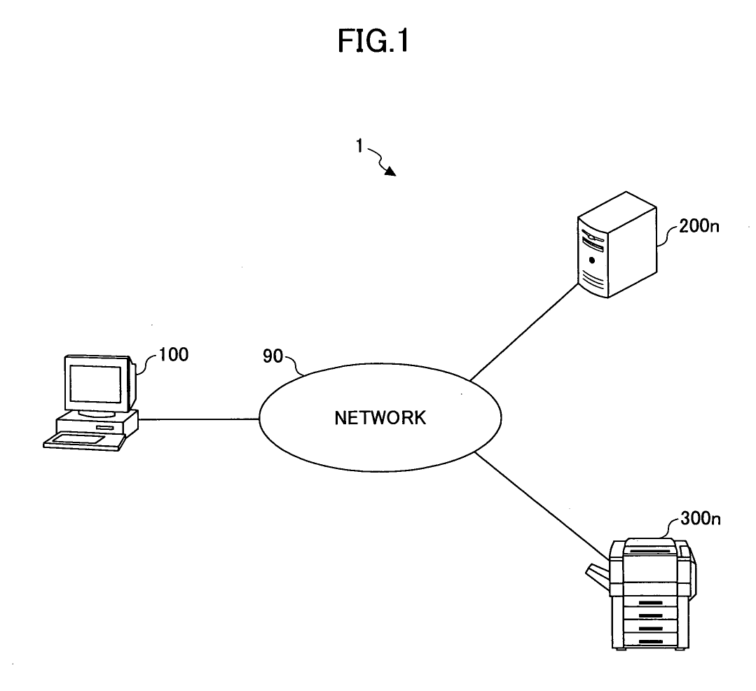

FIG. 1 shows the composition of a data processing system 1 of a first embodiment of the invention. The data processing system 1 of this embodiment includes an information processing device 100 which is used as a work station by an operator in charge, a document server 200n (apparatus A) which manages various kinds of data being dealt with in this system, such as document data and image data, and a MFP 300n (apparatus B) which has multiple functions including a copier, a printer, a scanner and a fax. These devices of the data processing system 1 are interconnected via a network (data communication network) 90, such as LAN (local area network) or WAN (wide area network). Thus, the system of this embodiment has the configuration of the kind that is generally constructed in office environment or the like.

The data processing system 1 of this embodiment carries out data processing through the following steps (1) to (3).

### (1) Data Registration

In the data processing system 1, various kinds of data being dealt with in daily business work are registered into the document server 200n (apparatus A), the MFP 300n (apparatus B), etc., and they are managed by these apparatuses A and B.

### (2) Processing Request

After the data are registered, any of the document server 200n (apparatus A) and the MFP 300n (apparatus B) transmits a data-processing request to the information processing device 100, in order to cause the information processing device 100 to perform data processing to the registered data.

### (3) Data-Processing Execution

The information processing device 100 performs data processing automatically in accordance with the procedure of data processing to be performed to data used as a processing object, in response to the received data-processing request.

The data processing system 1 of this embodiment uses the system composition and the data processing method mentioned above, and it is able to perform automatically the data processing in association with the data operation (data storage, change, etc.) performed by the operator in charge in daily business work. It is possible to ease the burden to the operator in charge when performing the data processing, and lower the possibility that the operator in charge makes a mistake.

In the data processing system 1 of FIG. 1, the document server 200n (apparatus A) and the MFP 300n (apparatus B) are illustrated as an example of a data management device having the function to manage the data dealt with in the data processing system 1. Either the document server 200n or the MFP 300n serves as the data management device in this embodiment.

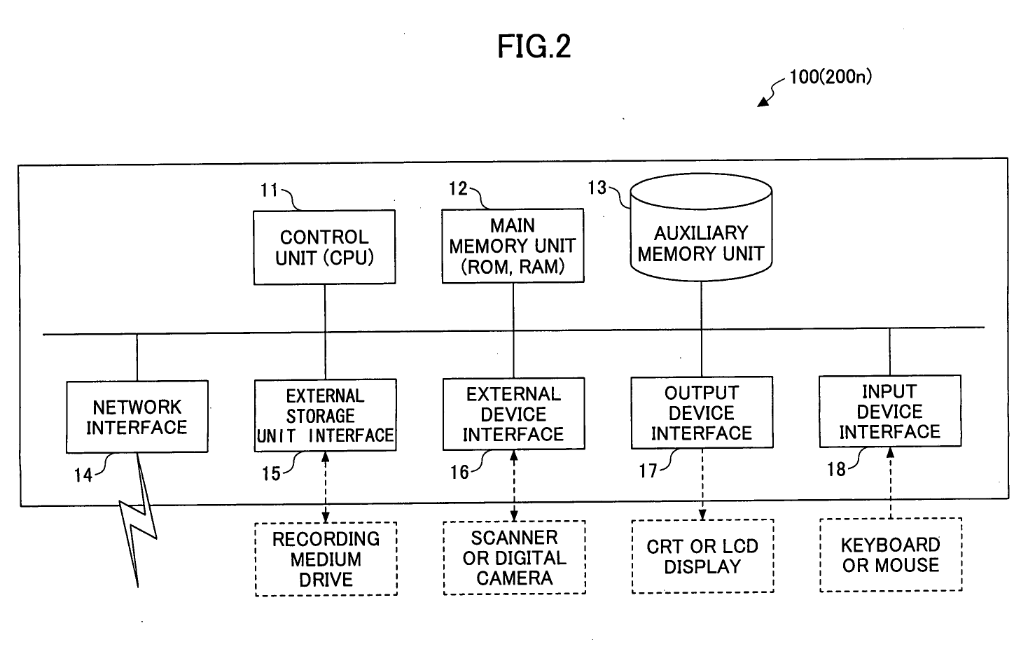

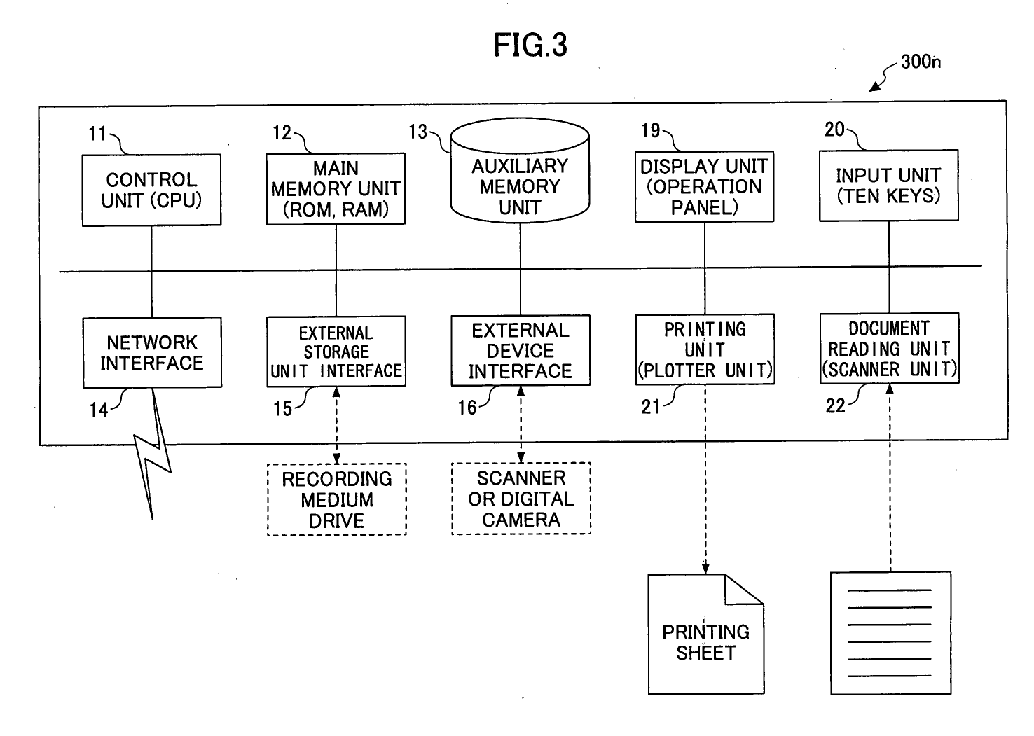

Next, the hardware composition of respective component devices which constitute the data processing system 1 of this embodiment will be explained with reference to FIG. 2 and FIG. 3.

The hardware composition of the information processing device 100 and the document server 200n (data management device 200n) in this embodiment will be explained with reference to FIG. 2.

FIG. 2 shows the hardware composition of the information processing device 100 in the first embodiment of the invention.

As shown in FIG. 2, the information processing device 100 of this embodiment includes a control unit 11, a main memory unit 12, an auxiliary memory unit 13, a network interface 14, an external storage interface 15, an external device interface 16, an output unit interface 17, and an input device interface 18.

The control unit (CPU) 11 controls the respective devices in the information processing device 100 of this embodiment, which include the main memory unit 12, the auxiliary memory unit 13, the network interface 14, etc.

The control unit 11 executes the program stored in the main memory unit 12 or the auxiliary memory unit 13. The control unit 11 receives data from an input unit or a storing unit, performs computations and processing of the data, and outputs the processed data to an output unit or a storing unit. For example, the control unit 11 processes the characters inputted from the keyboard and outputs them to the display unit.

The main memory unit (ROM, RAM) 12 is a storing device which stores the program executed by the control unit 11 and its related data (or stores them temporarily). The program executed by the control unit 11 and the related data are stored in the ROM, and the program and the related data from the ROM are loaded to the RAM by the control unit 11, if needed. Computations and processing of data are performed by the control unit 11 in accordance with the program and the related data on the RAM.

The auxiliary memory unit (HDD) 13 is a storing device which stores the OS (operating system) and the application program, including the information processing program of this embodiment and the plug-in software for function expansion, together with the related data. Also, in the auxiliary memory unit 13, various kinds of information (for example, definition information which defines the executing conditions and executing sequence of the plug-in software) are stored, and they are managed by the information processing device 100 of this embodiment with a database, a file system, etc.

The network interface 14 is an interface of the information processing device 100 of this embodiment to a peripheral device (for example, another information processing device, an image forming device, etc.) having a communication function and connected via a network, such as LAN (local area network) or WAN (wide area network), which is constructed with wired or wireless data transmission line.

The external storage interface 15 is an interface of the information processing device 100 of this embodiment to an external storage (for example, a memory media drive, etc.) connected via a data transmission line, such as USB (universal serial bus).

The external device interface 16 is an interface of the information processing device 100 of this embodiment to an external input device (for example, an external HDD, a USB memory, etc.) connected via a data transmission line, such as USB.

The information processing device 100 of this embodiment performs data exchange (transmitting/receiving or reading/writing) of various data with the external devices via these interfaces.

The output unit interface 17 is an interface of the information processing device 100 of this embodiment to an output unit (for example, a CRT display, a LCD display, etc.) connected via a data transmission line, such as a dedicated cable.

The input device interface 18 is an interface of the information processing device 100 of this embodiment to an input device (for example, a keyboard, a mouse, etc.) connected via a data transmission lines, such as USB.

The hardware composition of the MFP 300n (apparatus B) (which is also called the image forming device 300n) of this embodiment will be explained with reference to FIG. 3.

FIG. 3 shows the hardware composition of the image forming device 300n in the first embodiment of the invention.

As shown in FIG. 3, the image forming device 300n of this embodiment includes a control unit 11, a main memory unit 12, an auxiliary memory unit 13, a network interface 14, an external storage interface 15, an external device interface 16, a display unit (operation panel) 19, an input unit (operation unit) 20, a printing unit (plotter unit) 21, and a document reading unit (scanner unit) 22.

The control unit 11, the main memory unit 12, auxiliary memory unit 13, the network interface 14, the external storage interface 15, and the external device interface 16, which are included in the image forming device 300n of FIG. 3, are essentially the same as corresponding elements (with the same reference numerals) in the information processing device 100 of FIG. 2, and a description thereof will be omitted. Only the composition of the image forming device 300n different from that of the information processing device 100 will be explained below.

The display unit 19 and the input unit 20 are constituted by a LCD (liquid crystal display) provided with a touch-panel function (including a software key of GUI (graphical user interface)), and key switches (hardware keys), respectively. The display unit 19 and the input unit 20 form a display/input device which functions as a UI (user interface) when using the functions of the image forming device 300n.

The printing unit 21 is a plotter unit which receives image data and outputs the received image data to a copy paper (print sheet) through the electrophotographic printing process (exposure, latent image formation, developing, and transferring) using a laser beam.

The scanner unit 22 includes a line sensor comprised of CCD (charge coupled device) photoelectric transducers, an A/D converter, and a drive circuit for driving these components. The scanner unit 22 is a document reading unit which generates digital image data with 8-bit RGB image data by scanning a document set on a document reading surface (or a contact glass). This document reading unit reads electronically image information from a paper medium.

In the image forming device 300n of this embodiment, the control unit 11 executes the program stored in the storing unit, such as the main memory unit 12 or the auxiliary memory unit 13, and transmits control signals (control instructions) to respective relevant devices to control the respective relevant devices so that any of the multiple functions (copier, printer, scanner, fax, etc.) of the image forming device 300n as well as the data processing function on the data management device side of the data processing system 1 of this embodiment may be realized.

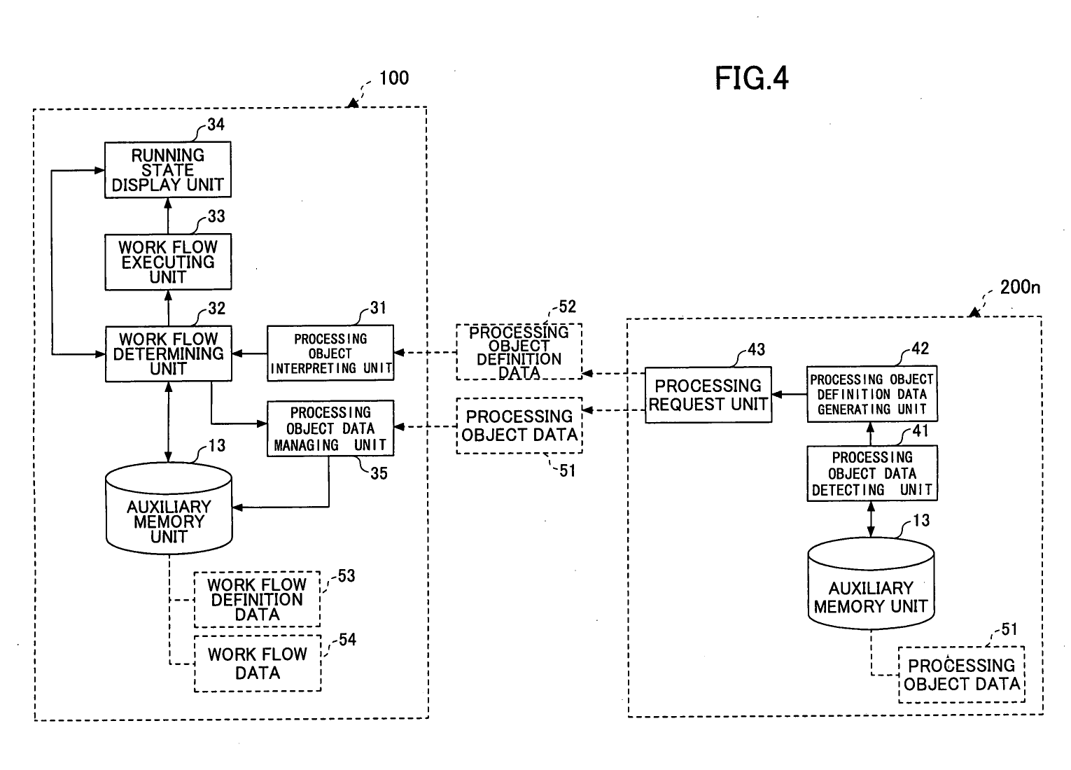

Next, the functional composition of the data processing system 1 of this embodiment will be explained with reference to FIG. 4.

FIG. 4 shows the functional composition of the data processing system 1 in the first embodiment of the invention.

Because the document server 200n and the image forming device 300 which are examples of the data management device in this embodiment have the same function, suppose that the functional composition of FIG. 4 includes only the document server 200n and the information processing device 100 as an example of the data processing system of this embodiment, for the sake of simplicity of description.

As shown in FIG. 4, the data processing system 1 of this embodiment is constituted by functions of the information processing device 100 and functions of the document server 200n. The functions of the information processing device 100 include a processing object interpreting unit 31, a work flow determining unit 32, a work flow executing unit 33, a running state display unit 34, and a processing object data managing unit 35. The functions of the document server 200n include a processing object data detecting unit 41, a processing object definition data generating unit 42, and a processing request unit 43.

Next, the respective functions of the information processing device 100 will be explained.

The processing object interpreting unit 31 provides a function which interprets the contents of processing object definition data 52 which defines information about processing object data 51 received from the document server 200n together with a request of data processing. Specifically, the processing object interpreting unit 31 uses the program (parser) which is capable of interpreting a structured programming language by which the processing object definition data 52 is described, interprets the processing object definition data 52, and acquires the information about the processing object data 51 defined in the data 52. The processing object definition data 52 will be described later.

The work flow determining unit 32 provides a function which determines a work flow which is a procedure used when performing data processing to the processing object data 51.

In the information processing device 100, at least one or more of the work flow data 54 (indicating the work flow as the procedure used when performing data processing) and the work flow definition data 53 (associating the processing object data 51 and the work flow data 54) are installed, and these data items are stored in the auxiliary memory unit 13.

The work flow determining unit 32 makes reference to the auxiliary memory unit 13 based on the information about the processing object data 51, acquired by the processing object interpreting unit 31 in response to the received data-processing request and specifies the corresponding work flow definition data 53 (i.e., the work flow definition data 53 in which the processing object data 51 corresponding to the received data-processing request and the work flow data 54 are defined).

Subsequently, the work flow determining unit 32 determines the work flow data 54 to be used when processing the processing object data 51 corresponding to the received data-processing request by making reference to the auxiliary memory unit 13 based on the information about the work flow data 54 defined in the specified work flow definition data 53.

The work flow executing unit 33 provides a function which performs data processing to the processing object data 51 in response to the data-processing request received from the document server 200n. Specifically, based on the work flow data 54 determined by the work flow determining unit 32, the work flow executing unit 33 transmits the executing command of the data processing to the relevant one of the functions (editing, outputting, state notifying) of the information processing device 100 and the functions of the apparatus other than the information processing device 100 connected to this system, and performs the data processing to the processing object data 51 corresponding to the received data-processing request.

The running state display unit 34 provides a function which displays a running state of the information processing device when performing the data processing to the processing object data 51 on a display screen of the display unit (CRT or LCD) connected to the information processing device via the output unit interface 17. Somme examples of the display screen displayed by the running state display unit 34 will be explained later.

The processing object data managing unit 35 provides a function which stores the processing object data 51 (received with the request of data processing from the document server 200n) in a predetermined storage area of the auxiliary memory unit 13 and manages the processing object data 51 stored therein.

Next, the respective functions of the document server 200n will be explained.

The processing object data detecting unit 41 provides a function which detects whether the processing object data 51 to be used as the object of data processing performed by the information processing device 100 is registered and updated. Specifically, the processing object data detecting unit 41 detects whether the processing object data 51 is stored in the predetermined storage area of the auxiliary memory unit 13, and detects the writing of data at the time of registering or updating.

The processing object definition data generating unit 42 provides a function which generates the processing object definition data 52 which defines the information about the processing object data 51 which is transmitted when requesting data processing of the information processing device 100. Specifically, when the data is registered or updated based on the detection result of the processing object data detecting unit 41, the registered or updated data is used as the processing object data 51. The processing object definition data generating unit 42 generates the processing object definition data 52 in which the information about the processing object data 51 is described in a structured programming language. This structured programming language is a markup language, such as XML (extensible Markup Language), for describing the meaning and structure of documents or data by embedding the meaning and structure in the sources codes by specific character strings called tags. In the case of XML, the user is allowed to specify tags at his option, and XML is used for this embodiment.

The processing request unit 43 provides a function which requests data processing of the processing object data 51 by transmitting the processing object definition data 51 to the information processing device 100 together with the processing object data 51. Specifically, the processing request unit 43 transmits, to the information processing device 100 via the network interface 14, the processing object data 51 (stored in the auxiliary memory unit 13) and the processing object definition data 52 (generated by the processing object definition data generating unit 42).

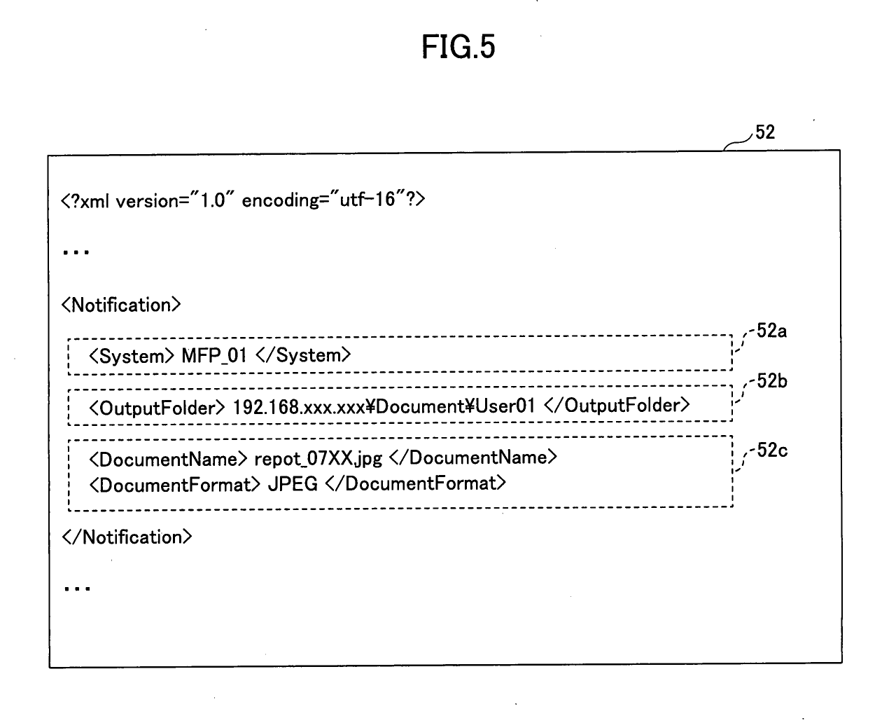

Next, the operation of the above-described data processing system 1 will be explained with reference to FIGS. 5 to 11.

The data processing system 1 of this embodiment performs the data processing by the following operations (1) to (5).

### (1) Detection of Data Registering/Updating by the Document Server 200n

The data processing system 1 causes the processing object data detecting unit 41 to detect whether the processing object data 51 which is an object of data processing being performed by the information processing device 100 is stored in a predetermined storage area of the auxiliary memory unit 13 in the document server 200n. This allows the detection of the data operation of the processing object data 51, such as registering, updating, etc. The detection result is transferred to the processing object definition data generating unit 42.

### (2) Request of Data Processing Transmitted by the Document Server 200n

The data processing system 1 causes the processing request unit 43 to transmit a request of data processing of the processing object data 51 to the information processing device 100. At this time, the processing request unit 43 transmits the processing object data 51 and the processing object definition data 52 (which defines the information about the processing object data 51) to the information processing device 100, in order to request execution of data processing of the processing object data 51.

The above-described processing object definition data 52 is generated by the processing object definition data generating unit 42.

Information about the processing object data 51 defined in the processing object definition data 52 of this embodiment includes: transmitting source information indicating from which apparatus the processing object data 51 is transmitted; storage location designating information indicating a storage area where the processing object data 51 is stored after transmission/reception; processing object data filename information indicating a filename of the processing object data 51; and data format information indicating a data format of the processing object data 51, and these information items are arranged and defined in a predetermined form. Since each information item is written in the structured programming language, the term “predetermined form” means that respective information items are defined by using predetermined tags corresponding to the respective information items.

FIG. 5 shows an example of the processing object definition data 52 in the first embodiment of the invention. As shown in FIG. 5, the processing object definition data 52 of this embodiment, generated by the processing object definition data generating unit 42, includes: the transmitting source information 52a (“MFP_{—}01” in FIG. 5) defined with the “<System>” tag; the storage location designating information 52b (“192.168.xxx.xxx¥ . . . ¥User01” in FIG. 5) defined with the “<OutputFolder>” tag; and the data filename/format information 52c containing processing object data filename information (“repot_{—}07XX.jpg” in FIG. 5) defined with the “<DocumentName>” tag and data format information (“JPEG” in FIG. 5) defined with the “<DocumentFormat>” tag. These information items are arranged and defined between the “<Notification>” and “</Notification>” tags which are used to define the information about the processing object data 51.

The data processing system 1 of this embodiment not only notifies the information processing device 100 that the processing object data 51 was stored in the predetermined storage area of the auxiliary memory unit 13, but also transmits the characteristics of the processing object data 51 which were described as the data filename and format. This enables the information processing device 100 to specify the data processing to be performed to the processing object data 51.

### (3) Interpretation of the Processing Request by the Information Processing Device 100

The data processing system 1 causes the processing request interpreting unit 31 to interpret the contents of the processing object definition data 52 (which defines the information about the processing object data 51) received, together with the request of data processing, from the document server 200n.

For example, when the processing object definition data 52 of FIG. 5 is interpreted by the processing request interpreting unit 31 (or when interpreted by the XML parser), the information about the processing object data 51, containing the transmitting source information 52a, the storage location designating information 52b, and the data filename/format information 52c, is acquired.

The data processing system 1 causes the processing object data managing unit 35 to store the processing object data 51 (received with the request of data processing from the document server 200n) in the predetermined storage area of the auxiliary memory unit 13 (specified by the storage location designating information 52b acquired by the processing object interpreting unit 31).

### (4) Determination of a Procedure of Data Processing by the Information Processing Device 100

The data processing system 1 causes the work flow determining unit 32 to determine a work flow which is a procedure for performing data processing to the processing object data 51.

The work flow data 54 which is used when performing data processing to the processing object data 51 is determined by the following steps (4-1) and (4-2).

### (4-1) Specifying Work Flow Definition Data 53

The data processing system 1 causes the work flow determining unit 32 to specify a corresponding work flow definition data 53 by making reference to the auxiliary memory unit 13 based on the information about the processing object data 51 acquired by the processing object interpreting unit 31.

The above-mentioned work flow definition data 53 is installed in the information processing device 100 and stored in the auxiliary memory unit 13.

The information which associates the processing object data 51 and the work flow data 54, contained in the work flow definition data 53 of this embodiment, includes; transmitting source information; storage location designating information; data format information; and work flow data filename information (which indicates a filename of the work flow data 54 to be used when performing data processing). These information items are arranged and defined in a predetermined form. The term “predetermined form” means that the information is defined using the tags corresponding to each predetermined information, similar to that in the processing object definition data 52.

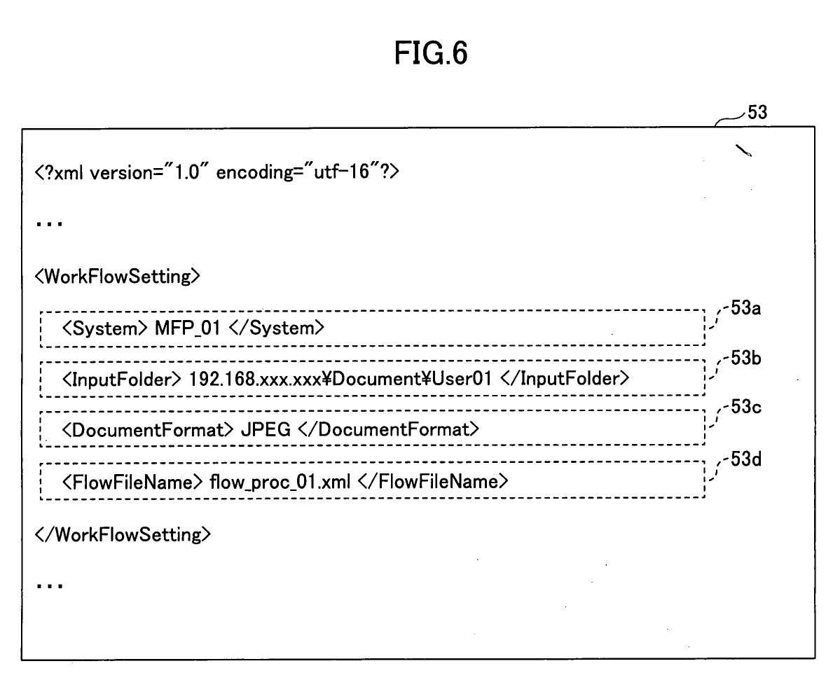

FIG. 6 shows an example of the work flow definition data 53 in the first embodiment of the invention. As shown in FIG. 6, the work flow definition data 53 of this embodiment includes: the transmitting source information 53a (“MFP_{—}01” in FIG. 6) defined with the “<System>” tag; the storage location designating information 53b (“192.168.xxx.xxx¥ . . . ¥User01” in FIG. 6) defined with the “<OutputFolder>” tag; the processing object data format information 53c (“JPEG” in FIG. 6) defined with the “<DocumentFormat>” tag; and the work flow data filename information 53d (“flow_proc_{—}01.xml” in FIG. 6) defined with the “<FlowFileName>” tag. These information items are defined as the information about the work flow data 54 and arranged between the “<WorkFlowSetting>” and “</WorkFlowSetting>” tags.

For example, the work flow determining unit 32 is arranged to compare the information about the processing object data 51 (transmitting source information 52a, storage location designating information 52b, and data format information 52c) which was acquired by the processing object interpreting unit 31, with the information defined in the work flow definition data 53 (transmitting source information 53a, storage location designating information 53b, and data format information 53c), and determine, based on a result of the comparison, whether work flow definition data 53 having each information item matched exist among the work flow definition data 53 stored in the auxiliary memory unit 13. Based on a result of the determination, the work flow definition data 53 is specified.

In the work flow definition data 53 of this embodiment, two or more work flow data items (not shown) each having one work flow data filename information 53d defined with the “<FlowFileName>” tag, may be defined and arranged in two or more lines. Alternatively, a specific tag with which a priority of two or more work flow data items 54 is defined, such as a “<Priority>” tag, may be used additionally. The work flow determining unit 32 is able to determine one of the two or more work flow data items in accordance with a predetermined priority rule of the thus defined work flow definition data 53.

### (4-2) Determining the Work Flow Data 54

In the information processing unit 100, the work flow data 54 which is indicated by the work flow data filename information 53d in the work flow definition data 53 is installed in addition to the work flow definition data 53, and it is stored in the auxiliary memory unit 13.

The data processing system 1 causes the work flow determining unit 32 to make reference to the auxiliary memory unit 13 based on the work flow data filename information 53d in the specified work flow definition data 53, and to determine the work flow data 54 to be used when performing data processing to the processing object data 51 in response to the received data-processing request.

When two or more work flow data items 54 are defined in the work flow definition data 53, the work flow determining unit 32 determines one of the two or more work flow data items 54. For example, when two or more work flow data items 54 are defined in the work flow definition data 53 by arranging them in multiple lines each including one work flow data filename information 53d defined with the “<FlowFileName>” tag, one of the work flow data items 54 may be determined in accordance with a predetermined rule that the first one of the multiple lines of the work flow data filename information 53d indicates the filename of the highest priority work flow data 54.

### (5) Execution of Data Processing by the Information Processing Device 100

The data processing system 1 causes the work flow executing unit 33 to perform data processing to the processing object data 51, in response to the data-processing request received from the document server 200n.

The work flow executing unit 33 transmits the executing command of the predetermined processing to the respective function modules for performing the data processing, based on the work flow data 54 determined by the work flow determining unit 32, in order to perform the data processing to the processing object data 51.

In the work flow data 54, the execution conditions (operating conditions) and executing sequence of the functions (editing (processing), outputting, notifying, etc.) of the data processing system used when performing the data processing are described and defined in a structured programming language, such as XML.

Similar to the case of interpreting the contents of the definition data, the work flow executing unit 33 is able to interpret the executing conditions (operating conditions) and executing sequence defined in the data, using the program (parser) capable of interpreting the data describing language, and transmit the executing command to the respective function modules.

Next, some examples of the operation of the data processing system 1 of this embodiment will be explained below.

In the data processing system 1 of this embodiment, the processing object definition data 52 received as a data-processing request from the document server 200n is interpreted by the information processing device 100, and the work flow data 54 used when performing data processing of the processing object data 51 is determined from among the work flow data 54 beforehand prepared based on the information acquired as a result of interpreting, so that data processing is performed based on the determined work flow data 54. Thus, it is possible to perform automatically the data processing in association with the data operation (data storage, change, etc.) performed by the operator in charge in daily business work.

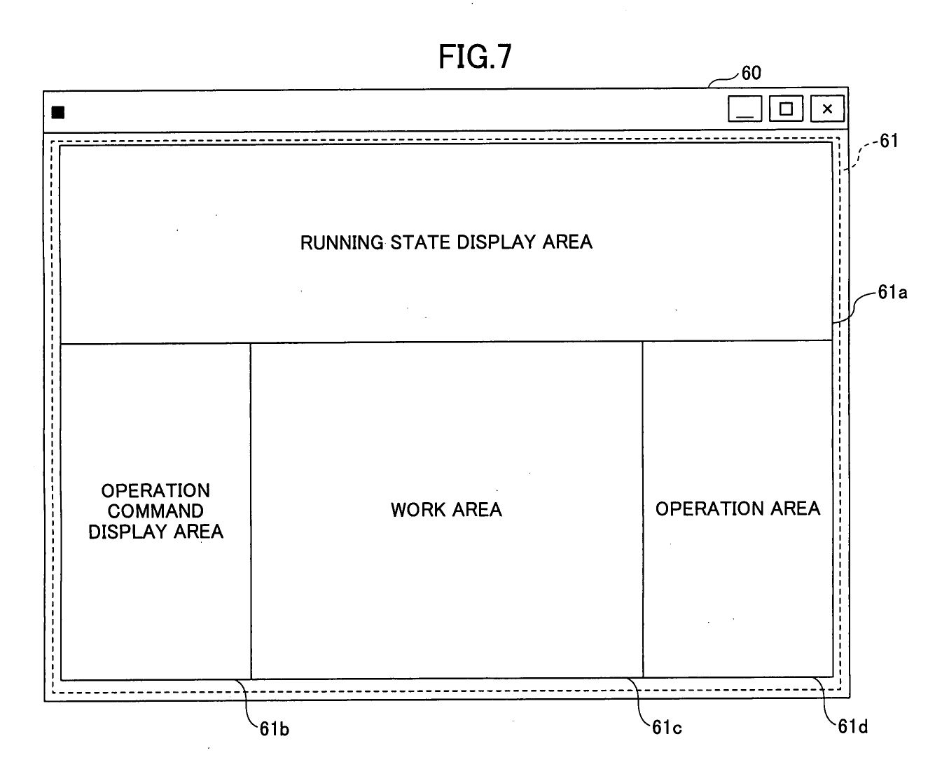

In the running state of the data processing system 1, the application window of the screen composition as shown in FIG. 7 is displayed in the display screen of the information processing device 100 used by an operator in charge as a terminal by the running state display unit 34.

FIG. 7 shows an example of the screen composition of a display screen 60 in the first embodiment of the invention.

As shown in FIG. 7, the display screen 60 has a display area 61 of the application window which includes a running state display area 61a which shows the running state of data processing, an operation command display area 61b in which input of an operation command needed in performing data processing is requested, a work area 61c in which data operation is performed, and an operation area 61d in which the operation conditions in performing data operation are selected or set up.

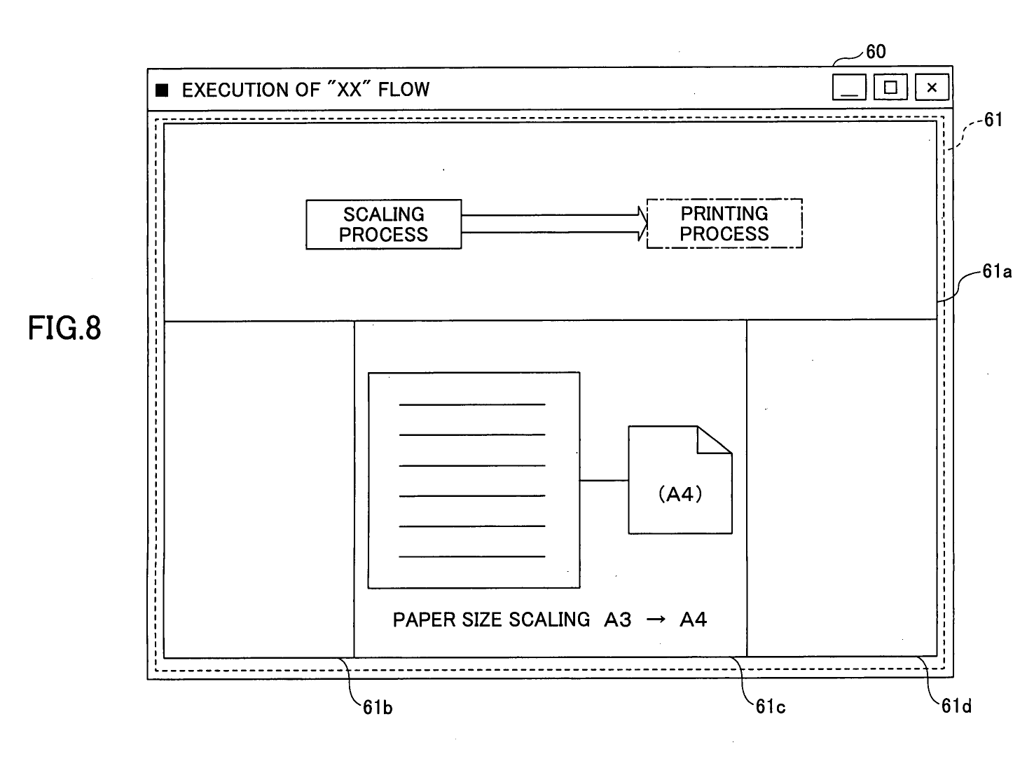

FIG. 8 shows an example of a display screen during operation of the data processing system of the first embodiment of the invention.

The example of FIG. 8 is a display screen at a time of execution of data processing in which the “XX” work flow that printing process is performed after scaling processing of a fixed form recording sheet is performed is defined in the work flow data 54.

As shown in FIG. 8, at the time of execution of the data processing, information indicating in what kind of state the process is currently running (for example, normally running) or what kind of the process is currently running, is displayed in the running state display area 61a and the work area 61c by the running state display unit 34. Thereby, the operator in charge can easily check the running state and progress of the data processing.

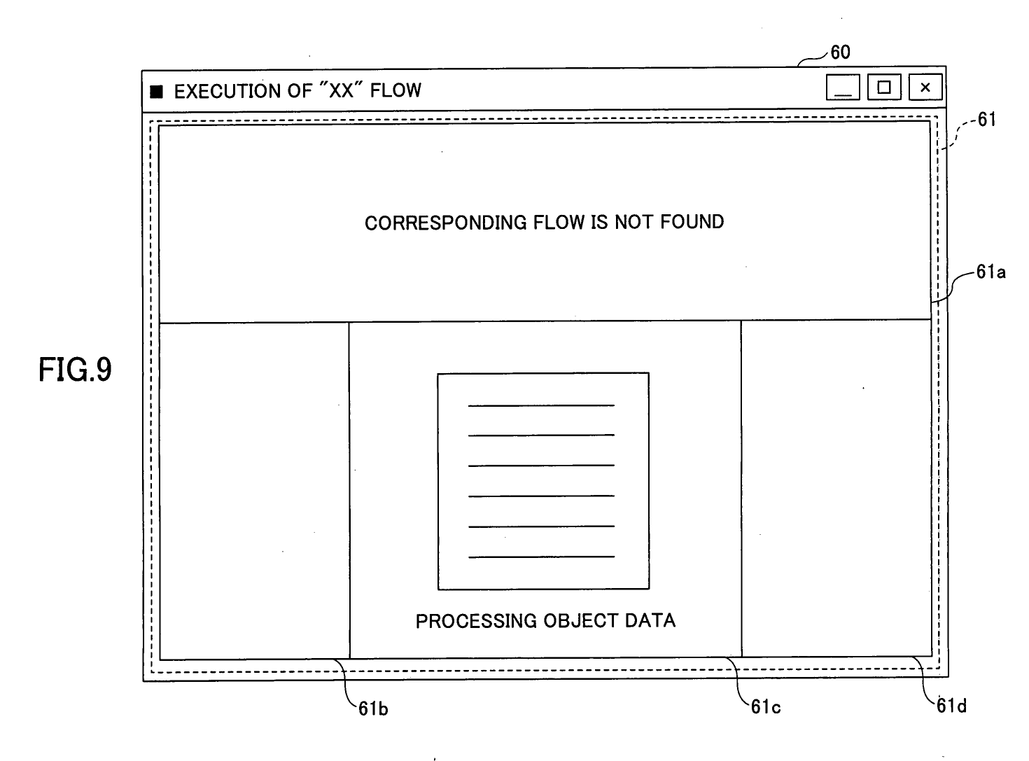

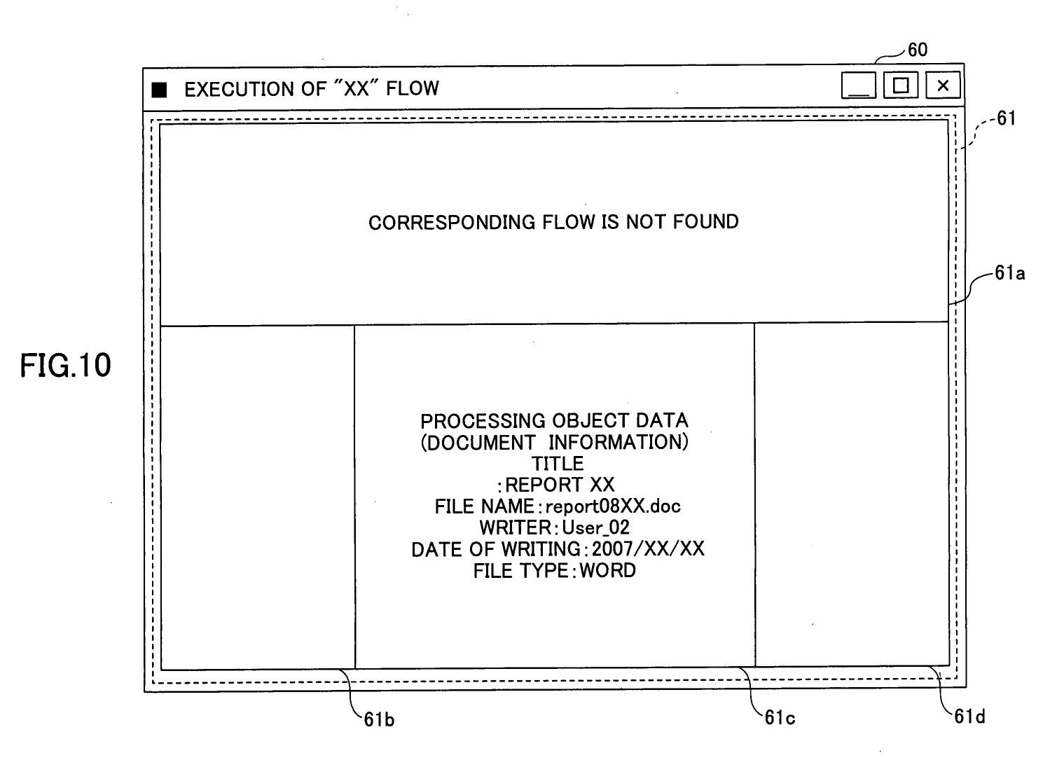

FIG. 9 and FIG. 10 show examples of the display screen 60 during operation of the data processing system of the first embodiment of the invention. The examples of FIG. 9 and FIG. 10 are the case of the display screen at a time of error in which a corresponding flow is found in the work flow data 53 when performing data processing.

When an error occurs at the time of execution of the data processing, the message indicating that the error has occurred is displayed in the running state display area 61a and the work area 61c by the running state display unit 34, as shown in FIG. 9 and FIG. 10.

In the example of FIG. 9, the processing object data 51 which caused the error is displayed as a document image in the work area 61c, and this can be detected visually by the operator in charge. In the example of FIG. 10, the bibliographic information which caused the error is displayed in the work area 61c, and the detailed information can be easily grasped by the operator in charge. Thereby, the operator in charge can easily specify the processing object data 51 which caused the error, and can easily check what kind of the cause of the error.

When an error occurs at a time of execution of the data processing, the processing object data managing unit 35 is arranged to move the processing object data 51 which caused the error from the storage area of the auxiliary memory unit 13 specified at a time of the data-processing request, to another storage area.

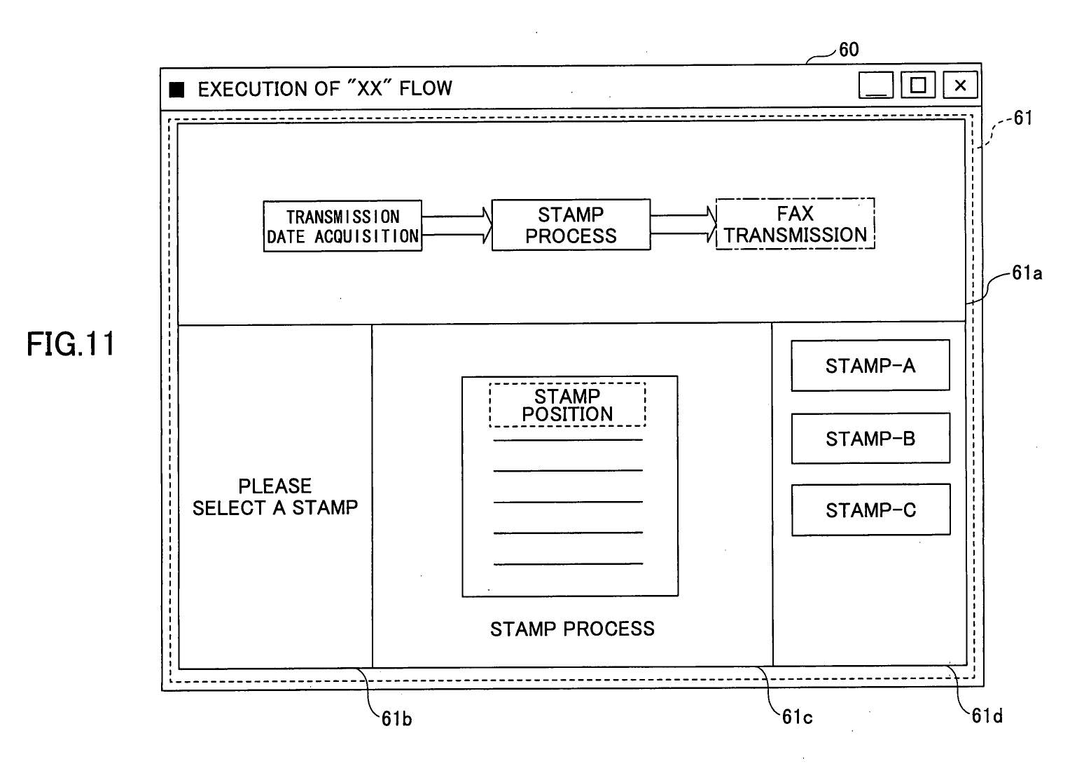

FIG. 11 shows an example of a display screen 60 during operation of the data processing system of the first embodiment of the invention.

The example of FIG. 11 is a display screen at a time of execution of data processing when the “XX” work flow that transmission date is acquired, a stamp of the acquired transmission date is added to the transmission data, and FAX transmission is performed” is defined in the work flow data 54.

Some data processing cannot be automated simply. For example, the example of FIG. 11 is a case in which the process that depends on the characteristics of the processing object data 51 (for example, adjusting the position of additional information according to the layout of the processing object data 51) must be performed.

In this case, the running state display unit 34 of this embodiment is arranged so that the message (“please select a stamp”) which requests the operator in charge to perform data operation is displayed in the operation command display area 61b, and the GUIs (graphical user interfaces) “stamp-A”, “stamp-B”, and “stamp-C” for requesting the operator in charge to perform data operation are displayed in the operation area 61d as shown in FIG. 11. Thereby, the operator in charge selects arbitrary one of the GUIs displayed in the operation area 61d by clicking it with the mouse. As a result, the operator can easily check the resulting data displayed in the work area 61c (the stamp position indicated by the dotted line in FIG. 11) and input the command of executing the following data processing. It is possible to avoid the work mistakes in the simply automated work flow process.

Because of the above-described functions, the data processing system 1 of this embodiment is able to perform automatically the data processing in association with the data operation (data storage, change, etc.) performed by the operator in charge in daily business work.

Next, the procedure performed by the data processing system 1 of this embodiment will be explained.

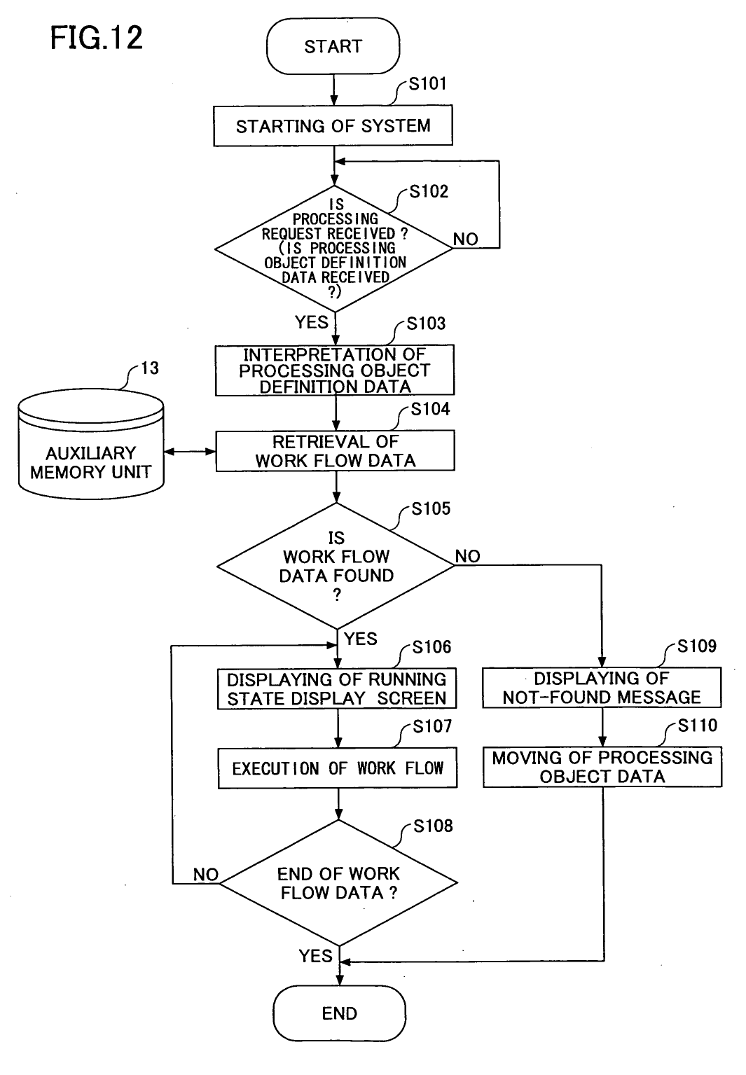

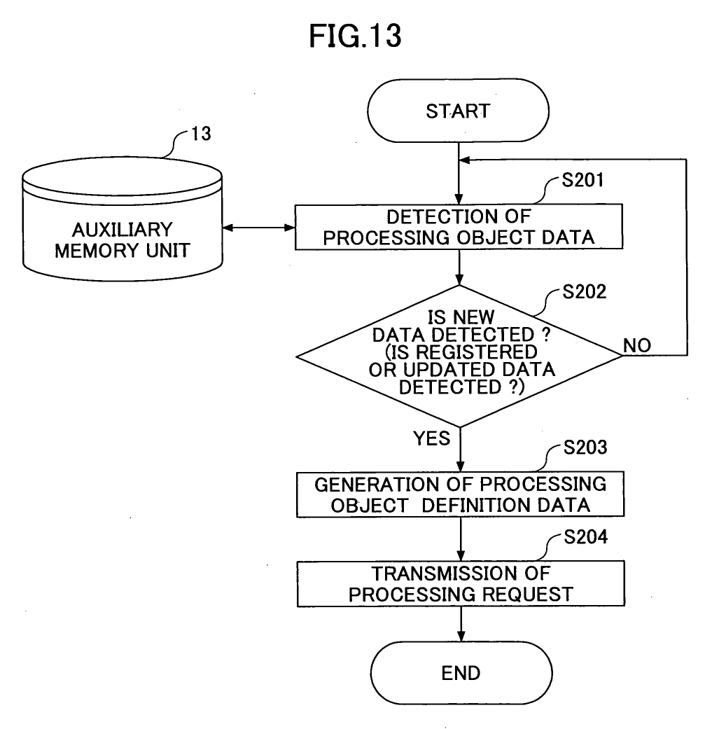

FIG. 12 is a flowchart for explaining the procedure performed by the information processing device 100 in the data processing system 1 of this embodiment. FIG. 13 is a flowchart for explaining the procedure performed by the document server 200n which is a data management device (apparatus) in the data processing system 1 of this embodiment.

The procedure of FIG. 12 is performed by the information processing device 100 of the first embodiment at a time of execution of a work flow.

For example, the information processing device 100 of this embodiment loads the data-processing program stored in the auxiliary memory unit 13, to the RAM of the main memory unit 12, and it is executed by the control unit 11 in order to perform data processing.

Upon starting of the system (S101), the information processing device 100 of this embodiment is held in a waiting state until it receives a data-processing request from the document server 200n (receiving of processing object definition data 52).

When a data-processing request is received (or when processing object definition data 52 is received) in step S102, the information processing device 100 causes the processing object interpreting unit 31 to interpret the contents of the received processing object definition data 52 using the program (parser) which can interpret data written in a structured programming language, and to acquire the information about the processing object data 51 defined therein (S103).

Next, the information processing device 100 causes the work flow determining unit 32 to specify the work flow definition data 53, which is stored beforehand in the auxiliary memory unit 13 and associates the processing object data 51 and the work flow data 54, based on the information about the processing object data 51 acquired by the processing object interpreting unit 31.

Next, the work flow determining unit 32 is caused to search the work flow data 54, which is stored beforehand in the auxiliary memory unit 13, based on the work flow data filename 53d defined in the specified work flow definition data 53 (S104).

At this time, the information processing device 100 causes the work flow determining unit 32 to determine whether the work flow data 54 with the corresponding filename exists in the auxiliary memory unit 13, and to determine the work flow data 54 which will be used in performing data processing, based on the result of the determination (S105).

When the work flow data 54 with the corresponding filename exists in the auxiliary memory unit 13, the information processing device 100 causes the running state display unit 34 to display the information which indicates the running state and progress of the data processing being performed, on the display screen 60 (S106).

Next, the information processing device 100 causes the work flow executing unit 33 to transmit the executing command of the predetermined processing to each function module performing the data processing, based on the work flow data 54 determined by the work flow determining unit 32, and performs data processing of the processing object data 51 (S107).

The information processing device 100 causes the work flow executing unit 33 to perform the data processing until all the functions defined in the work flow data 54 are performed according to the execution sequence.

When the work flow data 54 corresponding to the filename does not exist in the auxiliary memory unit 13, the information processing device 100 causes the running state display unit 34 to display the message indicating that there is no corresponding work flow data 54 on the display screen 60 (S109).

Next, the information processing device 100 causes the processing object data managing unit 35 to move the storage location of the processing object data 51 which caused the error, to another storage location (S110).

Through the steps S101-S110 in FIG. 12, the information processing device 100 of this embodiment receives the data-processing request from the document server 200n which is the data management device, and performs the data processing.

FIG. 13 is a flowchart for explaining the procedure at the time of the processing request of the apparatus (for example, the document server 200n) in the first embodiment of the invention.

For example, the document server 200n of this embodiment loads the data-processing program stored in the auxiliary memory unit 13, to the RAM of the main memory unit 12, and it is executed by the control unit 11 in order to perform data processing.

The document server 200n of this embodiment causes the processing object data detecting unit 41 to determine whether the processing object data 51 used as the processing object of data processing performed by the information processing device 100 is stored in the predetermined storage area of the auxiliary memory unit 13, and detects that data operation, such as registration, updating, etc., to the processing object data 51 is performed (S201).

When it is detected by the processing object data detecting unit 41 that the registration or updating is performed and the processing object data 51 is registered or updated (S202), the document server 200n causes the processing object definition data generating unit 42 to generate the processing object definition data 52 which defines the information about the processing object data 51 (S203).

As a result, the document server 200n causes the processing request unit 43 to transmit the processing object definition data 52 generated by the processing object definition data generating unit 42, together with the processing object data 51 detected by the processing object data detecting unit 41, to the information processing device 100 (S204).

When it is not detected in step S202 that the processing object data 51 is registered or updated, the control is returned to step S201 and the document server 200n repeats the detection processing of the processing object data 51.

The information processing device 100 of this embodiment transmits a request of data processing to the information processing device 100 by performing the steps S201-S204 in FIG. 13 (transmission of a data-processing request).

As mentioned above, the data processing system 1 according to the first embodiment of the invention has realized the automatic execution function of data processing in accordance with the following procedures.

### (Procedure 1) Registration and Renewal of Processing Object Data 51

The data processing system 1 of this embodiment with processing object data detecting unit 41, the processing object data 51 used as the processing object of data processing performed with information processing device 100 detects the data operation of processing object data 51 of registration, updating, etc. by judging whether it was stored in the predetermined storage area of auxiliary memory unit 13 in the document server 200n. The detection result is transferred to processing object definition data generating unit 42.

### (Procedure 2) Request of Data Processing

The data processing system 1 requires data processing of processing object data 51 of information processing device 100 by processing request unit 43. At this time, with processing object data 51, processing request unit 43 is transmitting processing object definition data 52 which defines the information about processing object data 51 to information processing device 100, and requires data processing of processing object data 51.

### (Procedure 3) Determination of Work Flow Data 54

The data processing system 1 interprets the contents of processing object definition data 52 with which the information about processing object data 51 transmitted by processing request interpreting unit 31 when requesting data processing from document server 200n was defined.

Next, the data processing system 1 specifies work flow definition data 53 which corresponds with reference to auxiliary memory unit 13 by work flow determining unit 32 based on the information about processing object data 51 acquired by processing object interpreting unit 31.

As a result, the data processing system 1 causes the work flow determining unit 32 to work flow data 54 used when processing the processing object data 51 which received the data-processing request with reference to auxiliary memory unit 13 based on 53d of work flow data filename information defined in the specified work flow definition data 53 are determined.

### (Procedure 4) Execution of Data Processing

The data processing system 1 causes the work flow executing unit 33 to transmit the executing command of the predetermined processing to each function module performing data processing, based on the work flow data 54 determined by the work flow determining unit 32, and performs data processing of the processing object data 51.

At this time, the information data processing system 1 indicates the running state and progress of data processing to be by running state display unit 34 is displayed on the display screen 60.

The data processing system 1 of this embodiment is able to determine that data operation, such as storing and updating, by performing the above procedures 1-4 and the data which serves as a data-processing object, and data processing can be automatically performed according to the predetermined procedure beforehand prepared corresponding to the data used as a processing object. It is able to perform automatically the data processing in association with the data operation (data storage, change, etc.) performed by the operator in charge in daily business work.

Therefore, the data processing system 1 of this embodiment can offer the data processing activities which an operator's in charge work burden in data processing is eased, and can prevent a work mistake.

The data processing system 1 of this embodiment is able to perform data processing based on the accessing right of the processing object data 51. As for a certain kind of data among the data dealt with in daily business work, such as document data describing information about a new product or image data which captures the appearance of a new product, the data operation including viewing is restricted and holding the confidentiality of information is also needed.

In such a case, the data processing cannot simply be performed as the processing object data 51, but it is necessary to determine whether the operator in charge has the authority to perform data processing based on the accessing right of data.

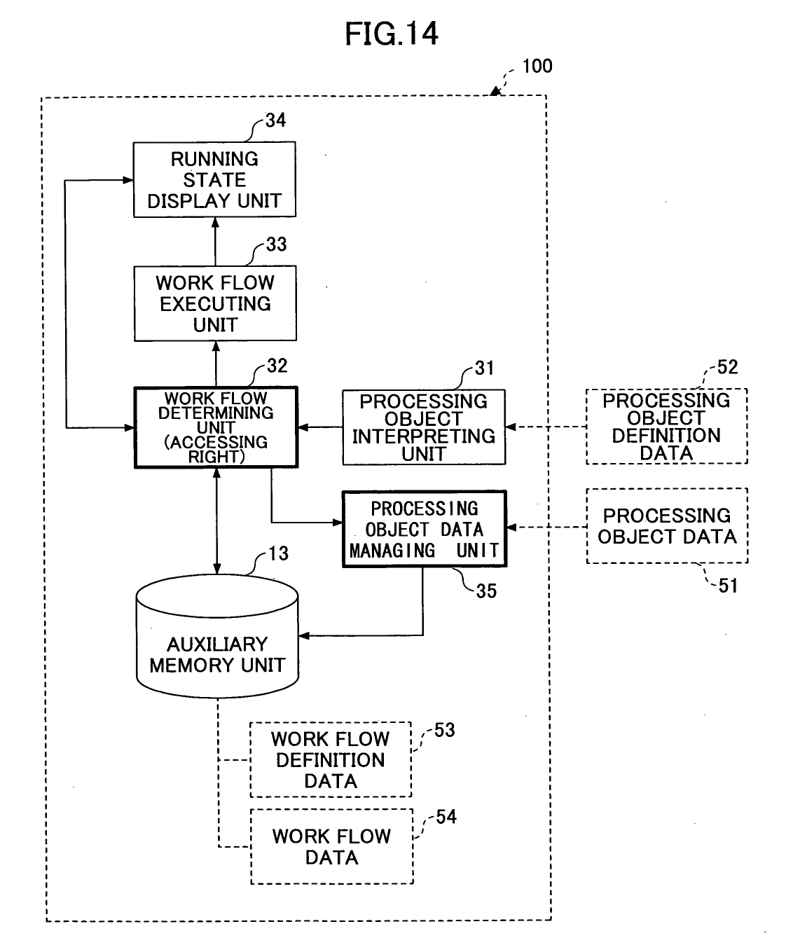

The data processing system 1 of the above-mentioned embodiment will be explained with reference to FIGS. 14-16.

In order to perform data processing based on the accessing right of processing object data 51, it is necessary to determine whether there is any authority for an operator in charge to perform data processing to processing object data 51. Therefore, execution of data processing based on the accessing right is controlled by data processing system 1 of this embodiment by the information processing device 100 side which an operator in charge uses. The present embodiment differs from the first embodiment in that it has the access control function.

In the following explanation, what is different from the first embodiment will be given, and duplicate explanation will be omitted.

FIG. 14 shows the functional composition of an information processing device 100 of a second embodiment of the invention.

The work flow determining unit 32 in the data processing system 1 of this embodiment has an access control function (which function determines whether access to the processing object data is accepted), in addition to the function of the work flow determining unit 32 in the first embodiment described above (which function determines the work flow data 54 based on the information about processing object data 51).

In the data processing system 1 of this embodiment, the information (accessing right information) relating to the accessing right of the processing object data 51 is defined in the processing object definition data 52 or the work flow definition data 53.

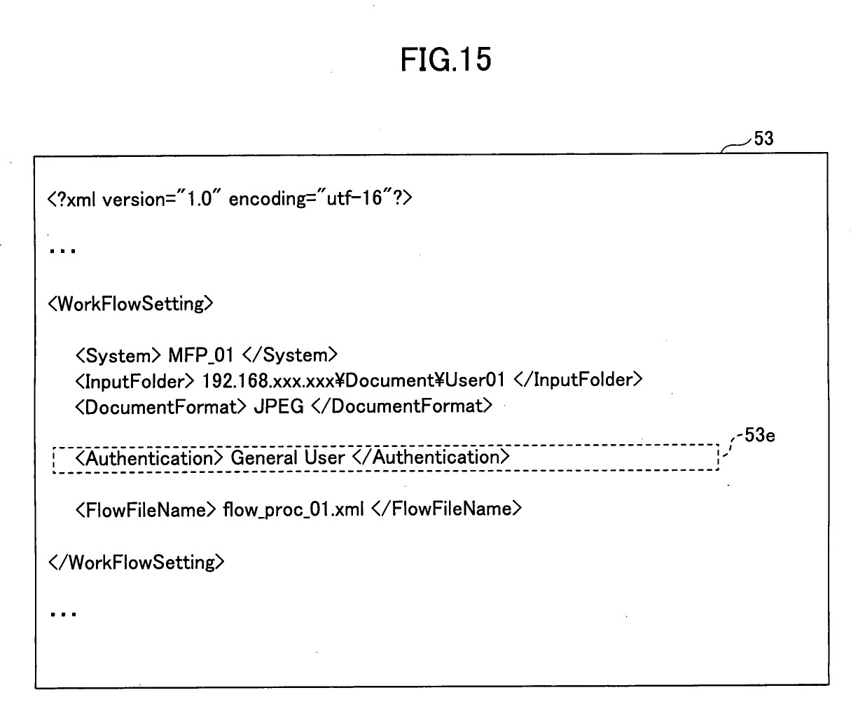

FIG. 15 shows an example of a work flow definition data 53 in the second embodiment of the invention. In the example of FIG. 15, the accessing right information “General User” of the processing object data 51 is defined in the work flow definition data 53.

As shown in FIG. 15, the accessing right information 53e of the processing object data 51 can be defined in the work flow definition data 53 with the “<Authentication>” tags.

When the accessing right information 53e is defined in the processing object definition data 52 or the work flow definition data 53 as shown in FIG. 15, the work flow determining unit 32 of this embodiment determines whether the operator in charge has the authority to perform data processing to the processing object data 51, based on the defined accessing right information 53e. Only when the operator has the authority, determination of the work flow data 54 is accepted.

When the accessing right information 53e is defined in the processing object definition data 52, the work flow determining unit 32 determines whether the operator in charge has the authority to perform data processing to the processing object data 54, based on the accessing right information 53e included in the information about the processing object data 51 acquired by the processing object interpreting unit 31, and based on the login information to this system of the operator in charge.

For example, suppose that the accessing right information 53e included in the information about the processing object data 51 is defined with “Project_A” such that only members of the project A are permitted to access data. In such a case, the work flow determining unit 32 determines whether determines whether the operator in charge is a member of the project A, based on the user attribute information included in the login information of the operator in charge. Only when the operator is a member of the project A, it is determined that the operator in charge has the authority.

When the accessing right information 53e is not included in the information about the processing object data 51 acquired by the processing object interpreting unit 31, the work flow determining unit 32 determines whether the operator in charge has the authority to perform data processing to the processing object data 54, based on the accessing right information 53e defined in the work flow definition data 53 specified based on the information about the processing object data 51, and based on the login information to this system of the operator in charge.

Only when it is determined by the work flow determining unit 32 that the operator in charge has the authority, determination of the work flow data 54 is accepted. When the operator in charge has no authority, the data processing is terminated at that time.

The data processing system 1 of this embodiment has the above-described access control function, and it is able to perform automatically the data processing in association with the data operation (data storage, change, etc.) performed by the operator in charge in daily business work, based on the accessing right of the processing object data 51.

Next, the procedure performed by the data processing system 1 of this embodiment will be explained.

In the following explanation, the portion about an access control function will be explained also in the procedure of data processing system 1, and about other procedures, since it is the same as the procedure performed in the first embodiment, explanation is omitted.

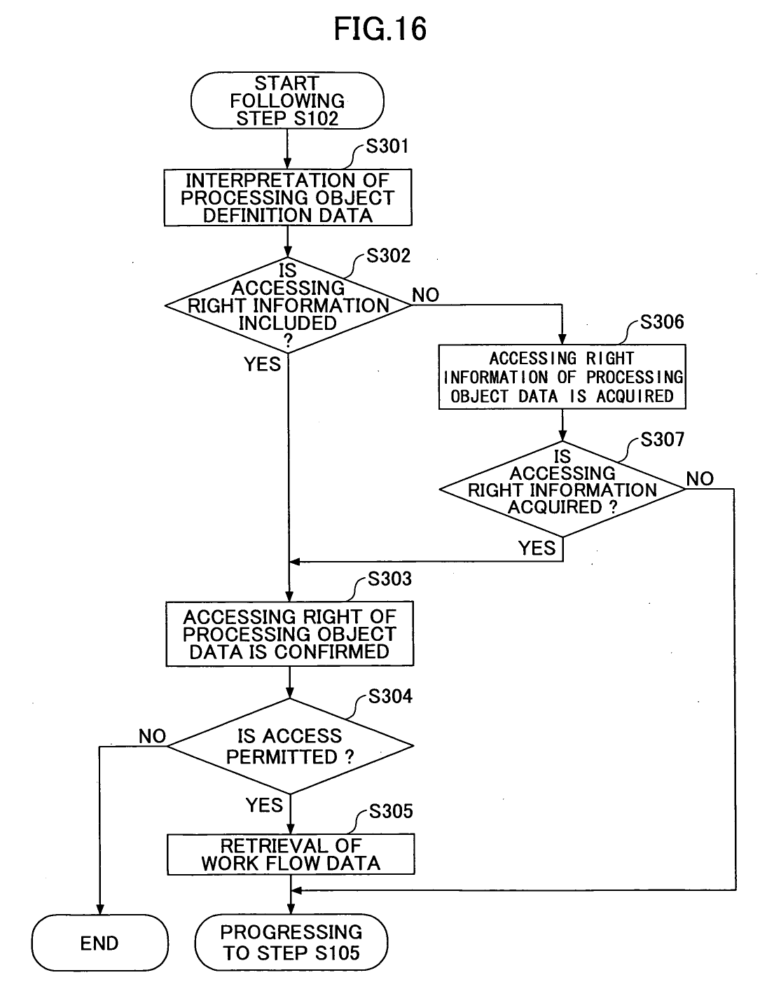

FIG. 16 is a flowchart for explaining the procedure of the access control function in the second embodiment of the invention at a time of execution of a work flow.

The procedure of the access control function shown in FIG. 16 should be performed between step S102 and step S105 which are performed by the information processing device 100 in the first embodiment as shown in FIG. 12.

The information processing device 100 of this embodiment causes the processing object interpreting unit 31 to interpret the contents of the processing object definition data 53, and to acquire the information about processing object data 51 defined in the processing object definition data 53 (S301).

The information processing device 100 causes the work flow determining unit 32 to determine whether the accessing right information 53e is included in the information about the processing object data 51 acquired by the processing object interpreting unit 31 (S302).

When the accessing right information 53e is included in the information about the processing object data 51, the information processing device 100 detects the accessing right of the processing object data 51 from the acquired accessing right information 53e (S303). The information processing device 100 determines whether the operator in charge has the authority for performing data processing of the processing object data 51 based on the user attribute information of the operator in charge (or whether the accessing is permitted or not) (S304).

When the determination result indicates that the accessing by the operator in charge is permitted, the work flow definition data 53 is specified based on the information about the acquired processing object data 51. Based on the work flow data filename information 53d defined in the specified work flow definition data 53, the corresponding work flow data 54 is searched from the auxiliary memory unit 13 (S305). The control progresses to the step S105.

On the other hand, when the accessing by the operator in charge is not permitted in step S304, the data processing is terminated.

When the accessing right information 53e is not included in the information about the processing object data 51 in step S302, the information processing device 100 specifies work flow definition data 53 based on the information about the acquired processing object data 51, and acquires accessing right information 53e of the processing object data 51 defined in the specified work flow definition data 53 (S306).

Next, the information processing device 100 determines whether the accessing right information 53e of the processing object data 51 defined in the work flow definition data 53 has been acquired (S307).

When the determination result indicates that the accessing right information 53e has been acquired, the control progresses to step S303.

On the other hand, when the accessing right information 53e cannot be acquired in step S307, it is determined that the accessing right is not set up to the processing object data 54. The work flow data 54 is determined based on the work flow data filename information 53d defined in the specified work flow definition data 53, and the control progresses to step S105.

The information processing device 100 of this embodiment carries out data processing in accordance with the accessing right of the processing object data 51 by performing the steps S301-S307 in FIG. 16.

As mentioned above, the data processing system 1 of this embodiment is arranged to determine that data operation, such as storing and updating, to data used as a data-processing object is performed. Only when an operator in charge has the authority for performing data processing, based on the accessing right of the data used as the processing object, data processing can be performed automatically in accordance with a predetermined procedure which is set up beforehand in association with the data used as the processing object. That is, according to the accessing right of the data used as the processing object, execution of data processing is controllable.

The data processing system 1 of this embodiment can offer the data processing activities which an operator's in charge work burden in data processing is eased, and can prevent a work mistake.

The data processing system 1 of this embodiment can perform data processing corresponding to the procedure of data processing used as the procedure and change of new data processing.

For example, the procedure of data processing performed on daily business work, such as reorganization and change of customer correspondence, cannot necessarily be dealt with as a formatted job.

In such a case, by the mechanism in which specific persons in charge, such as an administrator of this system, correspond, it cannot respond promptly but the environment where the usual operator in charge can make the new registration and change of the procedure of data processing simple from there being a possibility of causing trouble depending on the case is required for business.

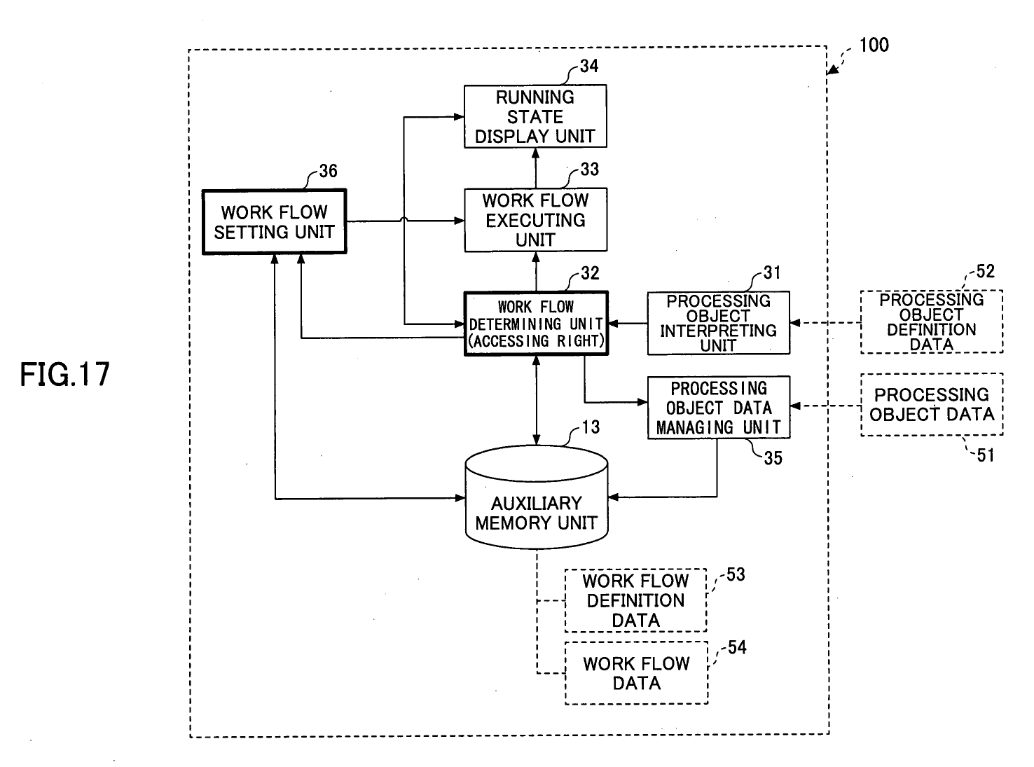

Next, the data processing system 1 of this embodiment adapted to eliminate the above-mentioned problem will be explained with reference to FIGS. 17-23.

In order to perform data processing based on the accessing right of the processing object data 51, it is necessary to determine whether the operator in charge has any authority for performing data processing to the processing object data 51. For this purpose, the data processing system 1 of this embodiment is arranged so that execution of data processing based on the accessing right is controlled by the information processing device 100 which is used by the operator in charge.

FIG. 17 shows the functional composition of an information processing device 100 in the third embodiment of the invention.

The data processing system 1 of this embodiment includes a work flow setting unit 36 which sets up a work flow which is a procedure of data processing.

When the work flow determining unit 32 cannot specify a processing object definition data 52 or when the work flow determining unit 32 cannot determine a work flow data 54, the work flow setting unit 36 associates the processing object data 51 with a newly generated work flow data 54 or a changed work flow data 54, and defines the association of the data 51 and the data 54 in the work flow definition data 53.

When the work flow data 54 to be associated with the processing object data 51 is changed, the work flow setting unit 36 requests the operating state display unit 34 to display a GUI for changing association of the work flow data 54 with the processing object data 51 on the display screen.

The work flow setting unit 36 associates the work flow data 54, which is changed and set up by the operator in charge, with the processing object data 51, updates the work flow definition data 53, and stores the updated work flow definition data 53 in the auxiliary memory unit 13.

The work flow setting unit 36 acquires the updated work flow data 54 from the auxiliary memory unit 13 and transfers it to the work flow executing unit 33.

When a work flow data 54 to be associated with the processing object data 51 is newly generated, the work flow setting unit 36 requests the operating state display unit 34 to display a GUI for associating a newly generated work flow data 54 with the processing object data 51 on the display screen.

The work flow setting unit 36 generates the new work flow data 54 in accordance with the setting instructions of the operator in charge, associates the generated work flow data 54 with the processing object data 51, and updates the work flow definition data 53. The work flow setting unit 36 stores the updated work flow definition data 53 and the generated work flow data 54 in the auxiliary memory unit 13. The work flow setting unit 36 transfers the generated work flow data 54 to the work flow executing unit 33.

The work flow executing unit 33 performs data processing of the processing object data 51 by sending the executing command of the predetermined processing to each function that performs the data processing, based on the work flow data 54 received from the work flow setting unit 36.

Because the updated work flow definition data 52 and the changed or newly generated work flow data 54 are stored in the auxiliary memory unit 13, the data processing system of this embodiment carries out data processing in the same manner as in the previously described first and second embodiments.

The data processing system 1 of this embodiment includes the above-described work flow setting unit 36, and the operator in charge is allowed to perform automatically data processing integrally with the data operation (data storage, change, etc.) performed in daily business work. This enables automatic execution of data processing which is in conformity with the new registration and change of the procedure of data processing flexibly.

Next, the procedure of the data processing system 1 of this embodiment will be explained based on the example of a work flow setting function of operation.

In the procedure performed by subsequent explanation, the portion about a work flow setting function will be explained also in the procedure of data processing system 1, and about other procedures, since it is the same as the procedure performed in the first embodiment, explanation is omitted.

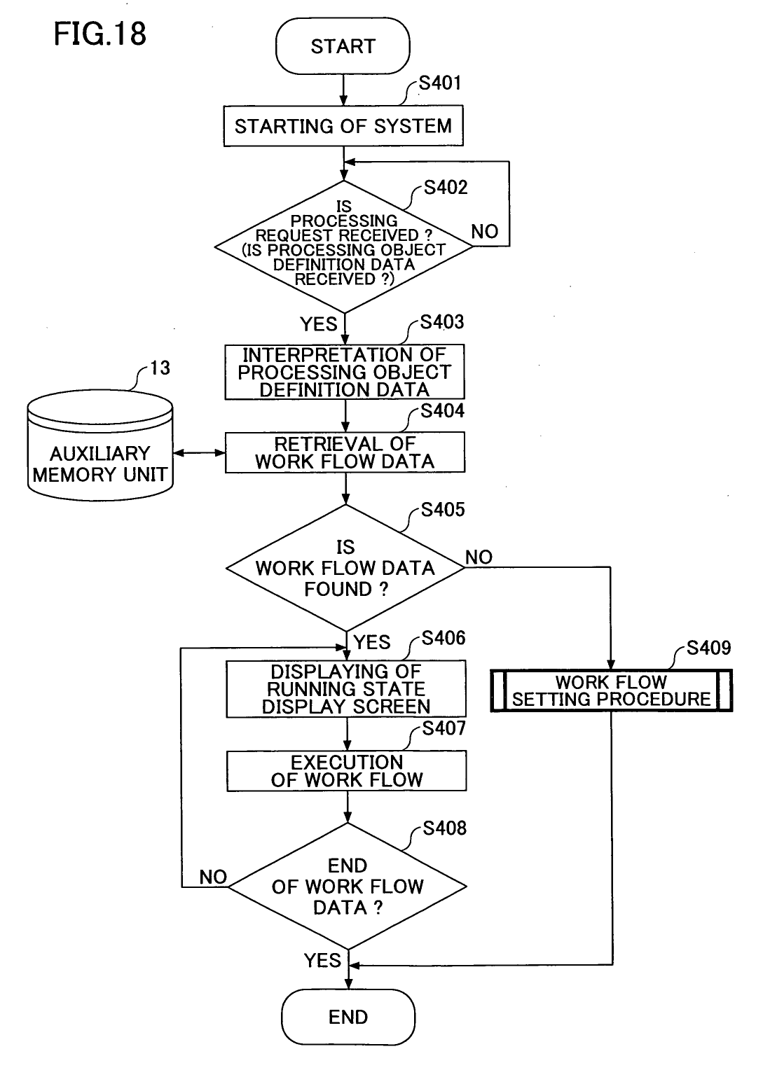

FIG. 18 is a flowchart for explaining the procedure performed by the third embodiment of the invention at a time of execution of a work flow.

The processing (S409) of the work flow setting function performed when step S105 which information processing device 100 which explained using FIG. 12 in the first embodiment performs is “NO” is shown in FIG. 18.

The procedure performed at step S409 shown in FIG. 18 below will be explained.

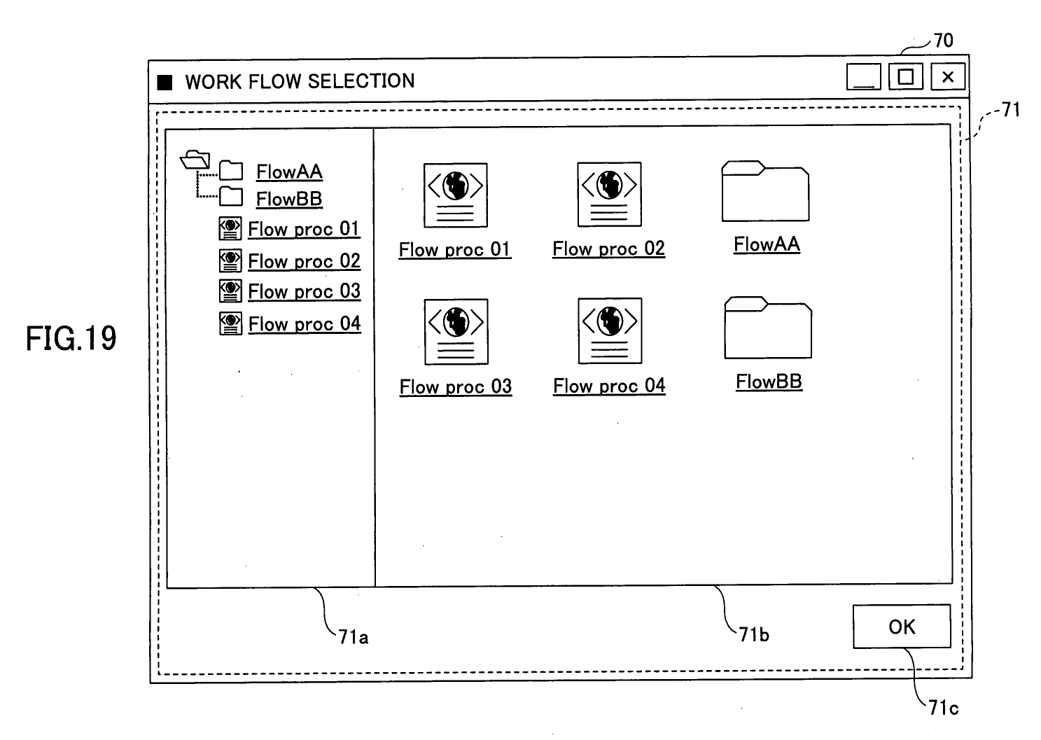

FIG. 19 shows an example of a display screen 70 during operation of the data processing system of the third embodiment of the invention.

The hierarchical structure display area 71a which displays the directory structure (hierarchical structure) of a storage area where work flow data 54 are stored on FIG. 19, an example of display area 71 of the application window which comprises work flow selecting area 71b which chooses work flow data 54 stored in the directory is shown.

The operator in charge chooses arbitrary work flow data 54 by this via GUI displayed on work flow selecting area 71b, and it is [symbol] which pushes OK button 71c (for example, it clicks with a mouse). The work flow data 54 associated with the processing object data 51 can carry out change command (work flow definition data 53 carries out updating command).

Already installed work flow data 54 and newly installed work flow data 54 can be made equivalent to processing object data 51 simple.

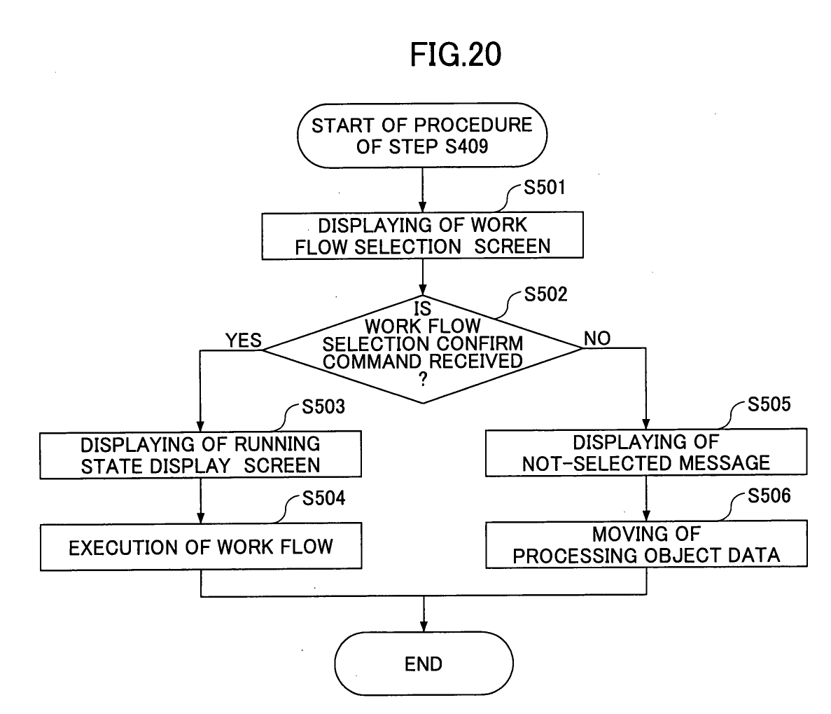

FIG. 20 is a flowchart for explaining the procedure of a work flow setting function in the third embodiment of the invention at a time of execution of a work flow.

In the processing (S409) of the work flow setting function shown in FIG. 18, the concrete procedure in the case of choosing the existing work flow is shown in FIG. 20.

The information processing device 100 of this embodiment accepts the display command from work flow setting unit 36. The GUI screen where running state display unit 34 can choose already installed work flow data 54 and newly installed work flow data 54 is displayed on the display screen 70 (S501).

The information processing device 100 determines whether the work flow setting unit 36 has received the selection confirm command of work flow data 54 through the running state display unit 34 (S502).

In the work flow setting unit 36, the information which shows the running state and progress of data processing performed called by running state display unit 34 which received the selection confirm command of work flow data 54 (when S502 is YES) is displayed on the display screen 60 (S503).

Next, the information processing device 100 causes the work flow executing unit 33 to transmit the executing command of the predetermined processing to each function module performing data processing, based on the work flow data 54 received from the work flow setting unit 36, and performs data processing of the processing object data 51 (S504).

When the selection confirm command of work flow data 54 is not received (a setup was not become final and conclusive), in work flow setting unit 36 (when S502 is NO) by the running state display unit 34, the contents which tell that work flow data 54 were not set up are displayed on the display screen 60 (S505).

Next, the information processing device 100 moves the storage location of processing object data 51 with which work flow data 54 were not associated by processing object data managing unit 35 to another storage location (S506).

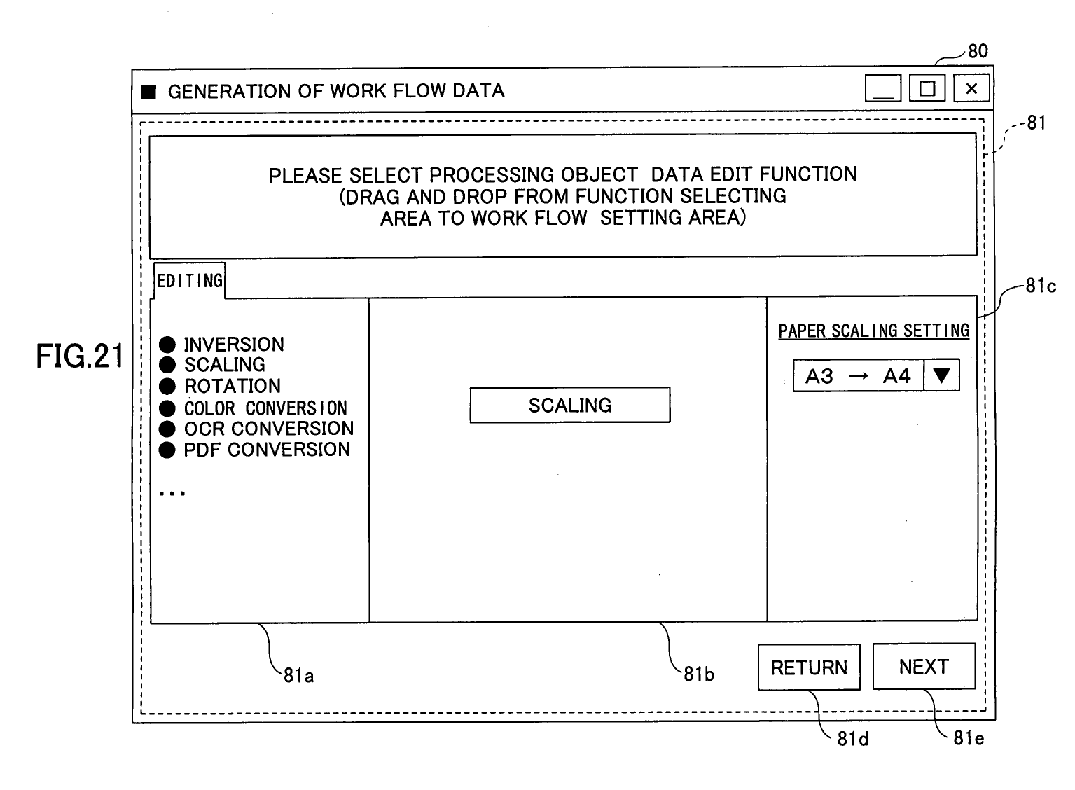

FIG. 21 shows an example of a display screen 80 during operation of the data processing system of the third embodiment of the invention.

The function selection area 81a which chooses an available function as data processing in FIG. 21 among the functions of this system, an example of display area 81 of the application window which comprises work flow setting area 81b which sets up new work flow data 54 based on the selected function, and execution condition setting area 81c which sets up the execution condition of the selected function is shown.

The operator in charge is moving to work flow setting area 81b, choosing and choosing a required function, when performing data processing via GUI displayed on function selection area 81a (it drags and drops with a mouse).

The new work flow data 54 associated with the processing object data 51 can be generated. A setup which advances the setting process and was finally performed until now by pressing the next button 81e to what (work flow definition data 53 carries out updating command) is become final and conclusive, the work flow data 54 which set up the procedure of new data processing can be made equivalent to processing object data 51 simple.

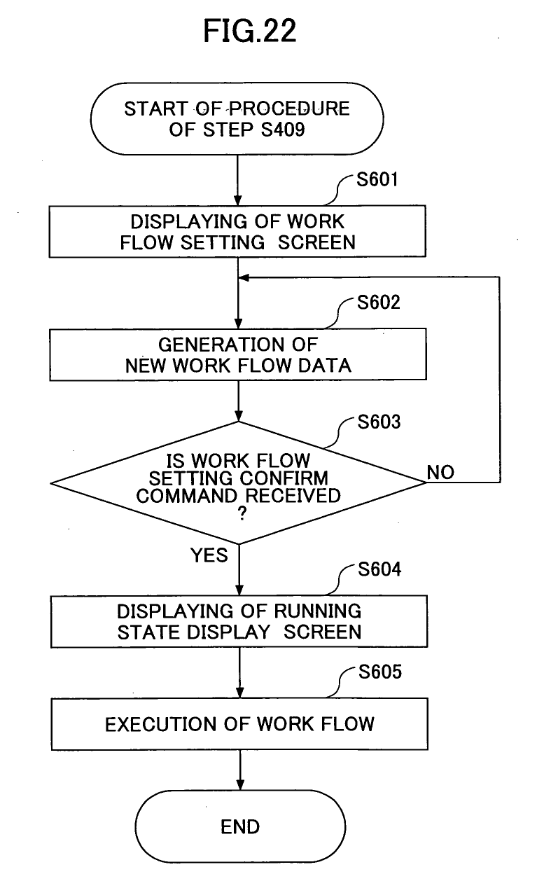

FIG. 22 is a flowchart for explaining the procedure of a work flow setting function in the third embodiment of the invention at a time of execution of a work flow.

In the processing (S409) of the work flow setting function shown in FIG. 18, the concrete procedure in the case of setting up a new work flow is shown in FIG. 21.

The GUI screen where information processing device 100 of this embodiment can set up work flow data 54 with new running state display unit 34 according to the display command from work flow setting unit 36 is displayed on the display screen 70 (S601).

The work flow setting unit 36 receives a setup of a procedure via running state display unit 34, and information processing device 100 generates new work flow data 54 (S602).

The information processing device 100 performs the processing of generating the work flow data 54 until the work flow setting unit 36 receives the setting confirm command of work flow data 54 via the running state display unit 34 in step S603.

When the work flow setting unit 36 receives the setting confirm command of work flow data 54 via running state display unit 34, information processing device 100 by the running state display unit 34, the information which shows the running state and progress of data processing performed called is displayed on the display screen 60 (S604).

Next, the information processing device 100 causes the work flow executing unit 33 to transmit the executing command of the predetermined processing to each function module performing data processing, based on the work flow data 54 received from the work flow setting unit 36, and performs data processing of the processing object data 51 (S605).

The information processing device 100 of this embodiment carries out data processing flexibly in response to the new registration and change of the procedure of the data processing by performing the steps S501-S506 in FIG. 20 and the steps S601-S605 shown in FIG. 22.

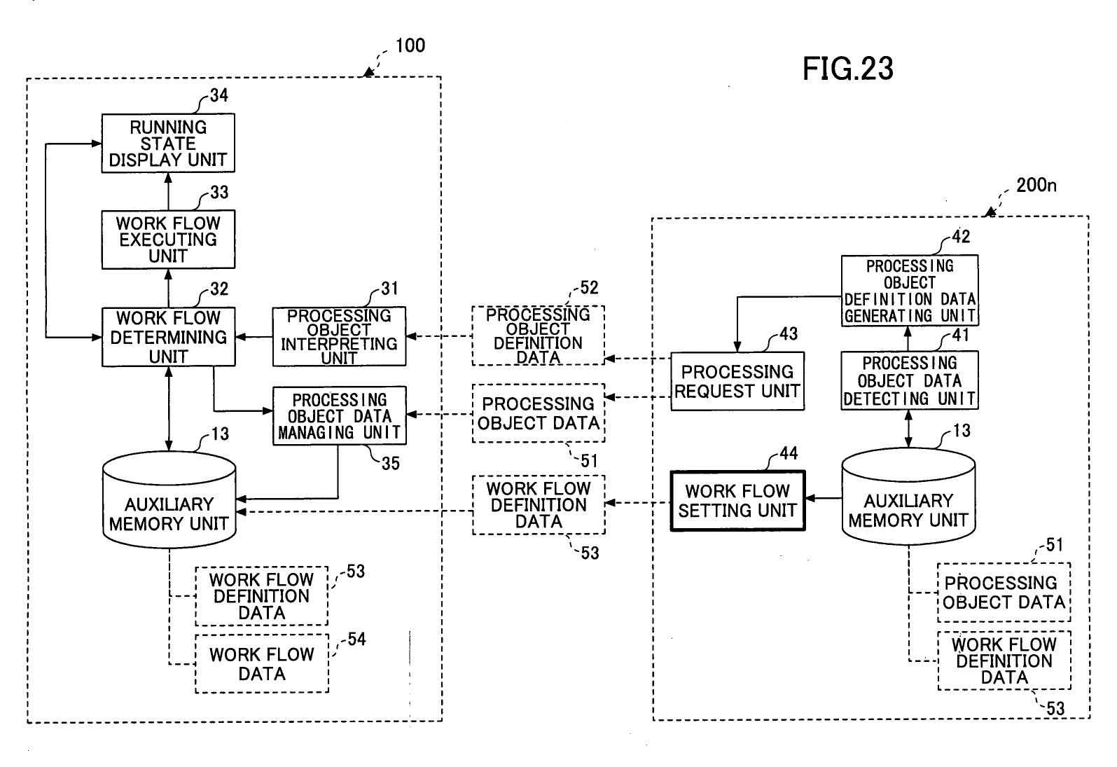

FIG. 23 shows the functional composition of a data processing system 1 of the third embodiment of the invention.

In the previous embodiment, the functional composition and operation when the information processing device 100 includes the work flow setting unit 36 have been explained. Alternatively, the functional composition in which the apparatus which is data management devices, such as document server 200n and MFP 300n, as shown in FIG. 23 has work flow setting unit 44 may also be used.

The data processing system 1 in this case when processing request unit 43 requires data processing by transmitting processing object definition data 52 to information processing device 100 with processing object data 51, the work flow setting unit 44 also transmits work flow definition data 53 required for data processing and work flow data 54 of processing object data 51 to information processing device 100.

By using the above-described functional composition, the updated work flow definition data 53 or work flow data 54 can be automatically installed in the information processing device 100. It is possible to automatically update the work flow definition data 53 and the work flow data 54, needed for performing the data processing, in association with the data operation (data storage, change, etc.) performed by the operator in charge in daily business work.

As mentioned above, the data processing system 1 of the third embodiment determines that data operation, such as storing and updating, to data used as a data-processing object is performed, and automatically performs data processing in accordance with a predetermined procedure which is set up again in association with the new registration or change of the procedure of data processing. Hence it is possible to take appropriate actions for the new registration and change of the procedure of data processing flexibly, in order to perform data processing.

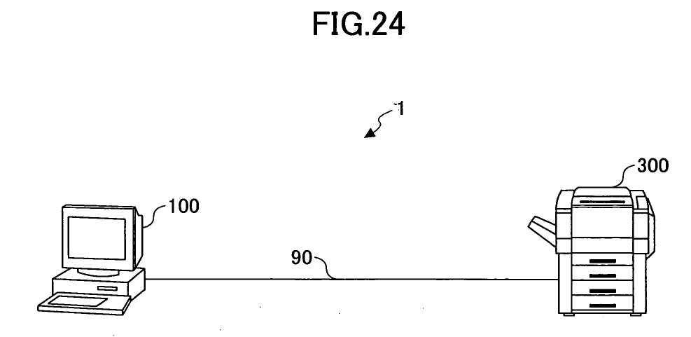

Next, FIG. 24 shows the composition of a modification of the data processing system 1 of the invention.

Unlike the composition of the first embodiment of FIG. 1, in the data processing system 1 shown in FIG. 24, an information processing device 100 which is used as a work station by an operator in charge, and an MFP 300n (apparatus B) which has multiple functions including a copier, a printer, a scanner and a fax, are interconnected via a network (network of data communication) 90, such as LAN or WAN.

In this data processing system, the MFP 300 is arranged to have the function that is the same as the data-processing automatic request function included in the data management device (the document server 200n) of the previous embodiment. The MFP 300 is able to determine that data operation, such as storing and updating, to data used as a data-processing object is performed, and automatically perform data processing in accordance with a predetermined procedure which is set up again in association with the new registration or change of the data used as the processing object. Thus, the operator in charge is allowed to perform automatically data processing integrally with the data operation (data storage, change, etc.) performed in daily business work.

Therefore, according to the data processing system 1 of this embodiment, it is possible to ease the burden to the operator in charge in data processing and lower the possibility that the operator in charge makes a mistake.

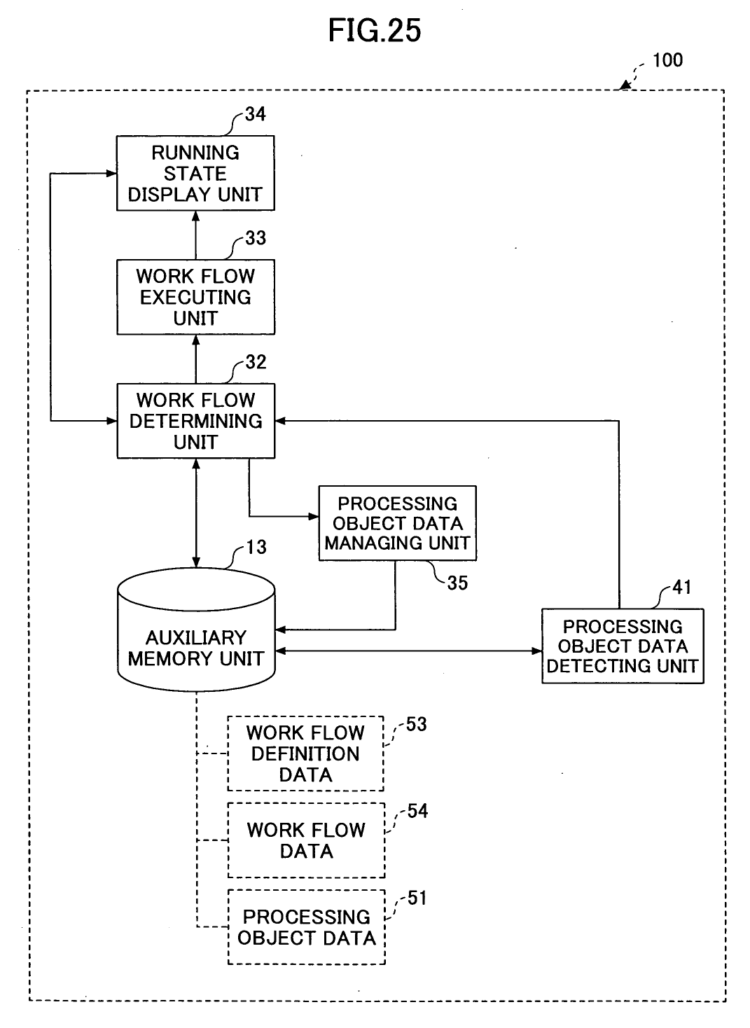

FIG. 25 shows the functional composition of a modification of the data processing system 1 of the invention.

In the data processing system 1 shown in FIG. 25, the information processing device 100 which is used as a work station by an operator in charge is arranged to have the processing object data detecting unit 41 as in the document server 200n of the first embodiment.

In the thus constructed data processing system, the information processing device 100 is able to determine that data operation, such as storing and updating, to data used as a data-processing object is performed, and to automatically perform data processing in accordance with a predetermined procedure which is set up again in association with the new registration or change of the data used as the processing object.

Therefore, according to the data processing system 1 of this embodiment with the modified information processing device 100, it is possible to ease the burden to the operator in charge in data processing and lower the possibility that the operator in charge makes a mistake.

Each function of the data processing system 1 in each of the above-mentioned embodiments is realized by the control unit 11 which executes the data-processing program written in a structured programming language appropriate for the operating environment (platform). The data-processing program can be recorded in a computer-readable recording medium. The information processing device 100 of the invention reads out the data-processing program from this recording medium via the external storage interface 15, and stores it in the predetermined storage area of the auxiliary memory unit 13, so that the data processing can be performed by the data processing system 1.

The present invention is not limited to the specifically disclosed embodiments, and variations and modifications may be made without departing from the scope of the present invention.

The present application is based on Japanese patent application No. 2007-196170, filed on Jul. 27, 2007, the contents of which are incorporated herein by reference in their entirety.

What is claimed is:

1. A data processing method for use in a data processing system in which an apparatus having a storing unit for storing data, and an information processing device for performing data processing in accordance with a predetermined procedure are interconnected via a network, the data processing method comprising:
a processing object data detecting step of detecting whether a processing object data, which is an object of data processing to be performed by the information processing device, is stored in a predetermined storage area of the storing unit of the apparatus;
a processing request step of transmitting a request of data processing of the processing object data from the apparatus to the information processing device based on a result of the detection in the processing object data detecting step; and
a work flow executing step of performing data processing to the processing object data in response to the request received from the apparatus.

2. The data processing method according to claim 1, wherein the apparatus comprises a processing object definition data generating unit configured to generate processing object definition data which defines information about the processing object data,
wherein the processing request step is arranged to transmit both the processing object data and the processing object definition data generated by the processing object definition data generating unit from the apparatus to the information processing device, to request the data processing of the processing object data.

3. The data processing method according to claim 1, wherein the information processing device comprises:
a work flow determining unit configured to determine a work flow which is a procedure of the processing object data; and
a processing object interpreting unit configured to interpret a processing object definition data which defines information about the processing object data, and acquire the information about the processing object data from the processing object definition data,
wherein the work flow determining unit determines a work flow which is a procedure of the processing object data, based on the information acquired by the processing object interpreting unit and the work flow definition data in which the processing object data and the work flow associated with the processing object data are defined.

4. The data processing method according to claim 3, wherein, when two or more work flows associated with the processing object data are defined in the work flow definition data, the work flow determining unit determines one of the two or more work flows as being a procedure of the processing object data in accordance with a predetermined priority rule.

5. The data processing method according to claim 3, wherein the work flow executing step is arranged to perform data processing to the processing object data in accordance with a work flow determined by the work flow determining unit.

6. The data processing method according to claim 1, wherein the information processing device comprises a work flow setting unit configured to set up a work flow which is a procedure of the processing object data.

7. The data processing method according to claim 6, wherein the work flow setting unit associates the processing object data with a work flow data indicating a work flow which is stored in the storing unit of the information processing device, and sets up the work flow.

8. The data processing method according to claim 6, wherein the work flow setting unit installs a work flow data indicating a work flow which is a procedure of the processing object data, associates the processing object data with the work flow data, and sets up the work flow.

9. The data processing method according to claim 6, wherein the information processing device comprises a work flow data generating unit configured to generate a work flow data indicating a work flow which is a procedure of the processing object data,
wherein the work flow setting unit causes the work flow data generating unit to generate the work flow data, associates the processing object data with work flow definition data, and sets up the work flow.

10. The data processing method according to claim 1, wherein the information processing device comprises a running state display unit configured to display a running state when processing the processing object data on a display screen.

11. The data processing method according to claim 10, wherein the running state display unit is configured to display a running state for every procedure in the data processing on a display screen.

12. The data processing method according to claim 10, wherein the running state display unit is configured to display, on a display screen, information notifying an execution error in the data processing or information about the processing object data causing an execution error.

13. A data management device connected with an information processing device which performs data processing in accordance with a predetermined procedure, the data management device managing a processing object data which is stored in a storing unit as being an object of data processing being performed by the information processing device, comprising:
a processing object data detecting unit configured to detect whether the processing object data is stored in a predetermined storage area of the storing unit of the data management device; and
a processing request unit configured to transmit a request of data processing of the processing object data from the data management device to the information processing device based on a detection result of the processing object data detecting unit.

14. The data management device according to claim 13, further comprising a processing object definition data generating unit configured to generate a processing object definition data which defines information about the processing object data,
wherein the processing request unit transmits both the processing object data and the processing object definition data generated by the processing object definition data generating unit from the data management device to the information processing device, to request the data processing of the processing object data.

15. An information processing device comprising:
a unit configured to perform data processing in accordance with a predetermined procedure; and
a work flow executing unit configured to perform data processing to a processing object data which is an object of data processing performed by the information processing device, in response to a processing request.

16. The information processing device according to claim 15, further comprising:
a work flow determining unit configured to determine a work flow which is a procedure of the processing object data; and
a processing object interpreting unit configured to interpret a processing object definition data which defines information about the processing object data, and acquire the information about the processing object data from the processing object definition data,
wherein the work flow determining unit determines a work flow which is a procedure of the processing object data, based on the information acquired by the processing object interpreting unit and the work flow definition data in which the processing object data and the work flow associated with the processing object data are defined.

17. The information processing device according to claim 15, wherein, when two or more work flows associated with the processing object data are defined in the work flow definition data, the work flow determining unit determines one of the two or more work flows as being a procedure of the processing object data in accordance with a predetermined priority rule.

18. The information processing device according to claim 15, wherein the work flow executing unit performs data processing to the processing object data in accordance with the work flow determined by the work flow determining unit.

19. The information processing device according to claim 15, wherein the information processing device includes a running state display unit which displays a running state when processing the processing object data on a display screen.

20. The information processing device according to claim 19, wherein the running state display unit displays a running state for every procedure in the data processing on a display screen.
